(19) United States
(12) Patent Application Publication
(10) Pub. No.: US 2012/0316794 A1
(43) Pub. Date: Dec. 13, 2012

(54) METHOD AND A SYSTEM FOR MONITORING A PHYSIOLOGICAL PARAMETER OF A SUBJECT

(75) Inventors: Zenton Goh, Singapore (SG); Sian Sheng Neo, Singapore (SG); Hon Cheong Ng, Singapore (SG); Soh Min Lim, Singapore (SG); Wai Mun Ng, Singapore (SG); Jing Feei Teh, Singapore (SG); Soon Ann Ng, Singapore (SG)

(73) Assignee: CADI SCIENTIFIC PTE LTD, Singapore (SG)

(21) Appl. No.: 13/509,451

(22) PCT Filed: Nov. 18, 2010
(86) PCT No.: PCT/SG10/00436

§ 371 Date: May 31, 2012

Related U.S. Application Data
(60) Provisional application No. 61/261,781, filed on Nov. 17, 2009.

(51) Int. Cl. G06F 19/00

(52) U.S. Cl. 702/19

(57) ABSTRACT

Embodiments provide a method which includes transmitting, by a receiving device (RD), a request message which includes a receiving device identification number (RDIN); receiving, by the RD, a registration message including a measuring device identification number (MDIN) from a measuring device (MD); registering, by the RD, the MD by means of the MDIN if the registration message from the MD includes the RDIN; receiving, by the RD, one or more data messages from the MD, each data message including the MDIN and a physiological parameter; and processing the physiological parameter in each data message, by the RD, if the MD has been registered by the RD. The range of the transmission of the request message between the RD and the MD is shorter than the range of the transmission of each data message between the MD and the RD, and/or the range of the transmission of the registration message between the MD and the RD is shorter than the range of the transmission of each data message between the MD and the RD. Embodiments also provide a corresponding monitoring system.

The present application claims the benefit of the U.S. provisional application 61/261,781 (filed on 17 Nov. 2009), the entire contents of which are incorporated herein by reference for all purposes.

### FIELD OF INVENTION

The present invention relates generally to a method and a system for monitoring a physiological parameter of a subject.

### BACKGROUND

Recently, a wireless physiological parameter monitoring system starts to come into use. Typically in a wireless body temperature monitoring system, for example, each person may wear a temperature measuring device and the measured temperature by each temperature measuring device may be relayed wirelessly to a receiving device.

In some circumstances, it may be preferred that the receiving device only monitors a sub-group of measuring devices among a group of measuring devices, e.g. a measuring device among other measuring devices. That is, for example, if there are several patients in one room and each patient wears a respective measuring device, it may be preferred that the receiving device only monitors the physiological parameter of one of the patients in the room. For another example, among a group of patients that are in 2 different rooms, it may be preferred that the receiving device monitors the physiological parameter of the patients in one room only.

Further, traditionally, a tethered multi-parameter patient monitor is widely used to monitor the physical conditions of a subject, e.g. a patient. In this context, the tethered multi-parameter patient monitor refers to a multi physiological parameter monitoring device which may be used to measure a plurality of physiological parameters of the patient using respective measuring cables or probes. The physiological parameters that may be measured by the tethered multi-parameter patient monitor include, for example, body temperature, SpO2 (saturation of peripheral oxygen) and NIBP (non-invasive blood pressure).

When both the multi-parameter patient monitor and the wireless body temperature monitoring system are used at the same time, however, there may exist redundancy when the multi-parameter patient monitor also offers temperature monitoring using a tethered temperature probe. Further, if the wireless temperature monitoring system is used to monitor the body temperature of a patient and the multi-parameter patient monitor is used to monitor other physiological parameters of a patient, a healthcare personnel may have to observe two separate systems, namely the wireless temperature monitoring system for temperature readings and the multi-parameter patient monitor for other physiological readings such as SpO2 and NIBP.

Further, a tethered system requires a patient to be attached with dangling cables or probes and may be cumbersome to operate in some situations. A tethered system also inhibits patient mobility. Thus, there are advantages in using a wireless system and converting a conventional tethered system into a wireless one.

### SUMMARY OF THE INVENTION

Various embodiments provide a method and a system for monitoring a physiological parameter of a subject and overcome at least some of the problems mentioned above.

Embodiments provide a method for monitoring a physiological parameter of a subject by a monitoring system which includes a receiving device and a plurality of measuring devices each measuring a physiological parameter of a respective subject. The method may include transmitting, by a receiving device, a request message which includes a receiving device identification number of the receiving device. The method may further include receiving, by the receiving device, a registration message from at least one measuring device of the plurality of measuring devices. The registration message may include a measuring device identification number of the at least one measuring device. The method may further include registering, by the receiving device, the at least one measuring device by means of the measuring device identification number if the registration message from the at least one measuring device includes the receiving device identification number of the receiving device. The method may further include receiving, by the receiving device, one or more data messages from the at least one measuring device. Each data message may include the measuring device identification number of, and a physiological parameter from, the at least one measuring device. The method may further include processing the physiological parameter in each data message, by the receiving device, if the at least one measuring device has been registered by the receiving device. The range of the transmission of the request message between the receiving device and the at least one measuring device is shorter than the range of the transmission of each data message between the at least one measuring device and the receiving device, and/or the range of the transmission of the registration message between the at least one measuring device and the receiving device is shorter than the range of the transmission of each data message between the at least one measuring device and the receiving device.

Embodiments further provide an alternative method for monitoring a physiological parameter of a subject by a monitoring system which includes a receiving device and a plurality of measuring devices, wherein each measuring device is configured to measure a physiological parameter of a respective subject. The method may include registering, by the receiving device, at least one measuring device of the plurality of measuring devices by means of a measuring device registration identification number of the at least one measuring device, if a registration message including the measuring device registration identification number of the at least one measuring device from the at least one measuring device has been received by the receiving device. The method may further include receiving, by the receiving device, one or more data messages from the at least measuring device, each data message including a measuring device data transmission identification number of, and a physiological parameter from, the at least one measuring device. The method may further includes processing the physiological parameter in each data message, by the receiving device, if the at least one measuring device has been registered by the receiving device. The range of the transmission of the registration message between the at least one measuring device and the receiving device may be shorter than the range of the transmission of each data message between the at least one measuring device and the receiving device.

Embodiments further provide a system for monitoring a physiological parameter of a subject. The system may include a receiving device and a plurality of measuring devices wherein each measuring device is configured to measure a physiological parameter of a respective subject. The receiving device may be configured to transmit a request message which includes a receiving device identification number of the receiving device. The receiving device may be further configured to receive a registration message from at least one measuring device of the plurality of measuring devices. The registration message may include a measuring device identification number of the at least one measuring device. The receiving device may be further configured to register the at least one measuring device by means of the measuring device identification number if the registration message from the at least one measuring device includes the receiving device identification number of the receiving device. The receiving device may be further configured to receive one or more data messages from the at least one measuring device, wherein each data message includes the measuring device identification number of, and a physiological parameter from, the at least one measuring device. The receiving device may be further configured to process the physiological parameter in each data message, if the at least one measuring device has been registered by the receiving device. The range of the transmission of the request message between the receiving device and the at least one measuring device may be shorter than the range of the transmission of each data message between the at least one measuring device and the receiving device, and/or the range of the transmission of the registration message between the at least one measuring device and the receiving device may be shorter than the range of the transmission of each data message between the at least one measuring device and the receiving device.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a method for monitoring a physiological parameter of a subject according to one embodiment;

FIG. 2 shows a method for monitoring a physiological parameter of a subject according to an alternative embodiment;

FIG. 3 shows a system for monitoring a physiological parameter according to one embodiment;

FIG. 4 illustrates a measuring device according to one exemplary embodiment;

FIG. 5 illustrates a receiving device according to one exemplary embodiment;

FIG. 6 illustrates the registration of a measuring device with a receiving device according to one embodiment;

FIG. 7 illustrates the registration of more than one measuring device with a receiving device according to one embodiment;

FIG. 8 (a) illustrates an embodiment in which a second receiving device sends a request message to a measuring device after a first receiving device has registered the measuring device;

FIG. 9(a) illustrates the registration of a measuring device by a receiving device in one embodiment;

FIG. 9(b) illustrates that the receiving device is able to receive data messages from the registered measuring device when the receiving device is brought farther away from the registered measuring device in one embodiment;

FIG. 10 illustrates an embodiment wherein more than one measuring device receives a request message transmitted by a receiving device;

FIG. 11 (a) illustrates the registration of a measuring device by a receiving device in one embodiment; and

FIG. 11 (b) illustrates that the receiving device is able to receive data messages from the registered measuring device when the receiving device is brought farther away from the registered measuring device.

### DESCRIPTION

The following detailed description refers to me accompanying drawings that show, by way of illustration, specific details and embodiments in which the invention may be practiced. Because components of embodiments can be positioned in a number of different orientations, the directional terminology is used for purposes of illustration and is in no way limiting. Other embodiments may be utilized and structural, logical, and electrical changes may be made without departing from the scope of the invention. The various embodiments are not necessarily mutually exclusive, as some embodiments can be combined with one or more other embodiments to form new embodiments. The following detailed description therefore, is not to be taken in a limiting sense, and the scope of the present invention is defined by the appended claims.

The word “exemplary” is used herein to mean “serving as an example, instance, or illustration”. Any embodiment or design described herein as “exemplary” is not necessarily to be construed as preferred or advantageous over other embodiments or designs.

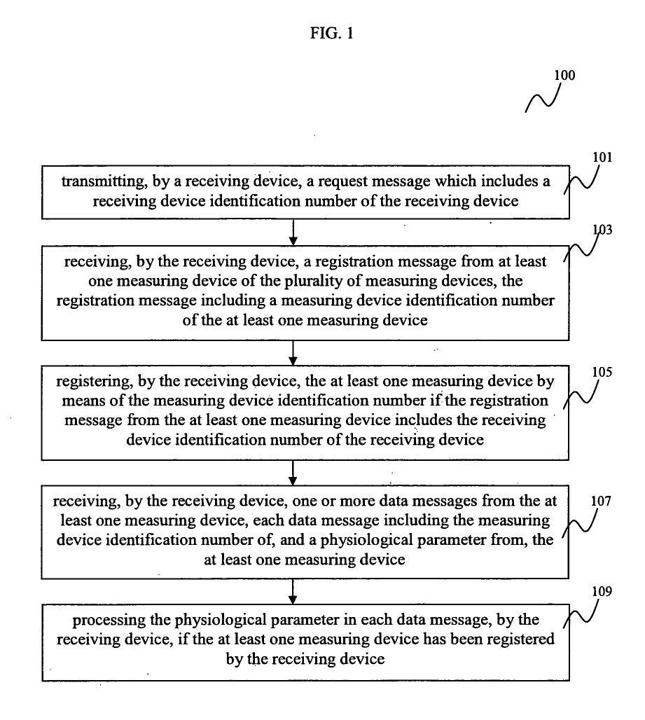

FIG. 1 shows a method 100 for monitoring a physiological parameter of a subject in one embodiment. The method may be carried out by a monitoring system which includes a receiving device and a plurality of measuring devices each measuring a physiological parameter of a respective subject.

The method 100 may include 101 transmitting, by a receiving device, a request message which includes a receiving device identification number of the receiving device. The method 100 may further include 103 receiving, by the receiving device, a registration message from at least one measuring device of the plurality of measuring devices, the registration message including a measuring device identification number of the at least one measuring device. The method 100 may further include 105 registering, by the receiving device, the at least one measuring device by means of the measuring device identification number if the registration message from the at least one measuring device includes the receiving device identification number of the receiving device. The method 100 may further include 107 receiving, by the receiving device, one or more data messages from the at least one measuring device, each data message including the measuring device identification number of, and a physiological parameter from, the at least one measuring device. The method 100 may further include 109 processing the physiological parameter in each data message, by the receiving device, if the at least one measuring device has been registered by the receiving device. In one embodiment, the range of the transmission of the request message between the receiving device and the at least one measuring device is shorter than the range of the transmission of each data message between the at least one measuring device and the receiving device, and/or the range of the transmission of the registration message between the at least one measuring device and the receiving device is shorter than the range of the transmission of each data message between the at least one measuring device and the receiving device.

In this context, when the receiving device registers the at least one measuring device, it may be referred to as that the receiving device is paired with the at least one measuring device.

In other words, in one embodiment, for example, a plurality of patients may be in one room, each lying on a bed and wearing a respective measuring device measuring the respective patient. It may be desired that a receiving device monitors, for example, the physiological parameter of one patient in the room. Thus, it may not be desirable that the receiving device processes measured physiological parameter transmitted by all the measuring devices in the room. Accordingly, in one embodiment, in order for the receiving device to process the physiological parameter transmitted by a measuring device A, the receiving device firstly registers the measuring device A and only processes the physiological parameter transmitted by the registered measuring device A. The receiving device may ignore or disregard the physiological parameter transmitted by other unregistered measuring devices. In order to register the measuring device A, the receiving device may first transmit a request message including a receiving device identification number of the receiving device. The measuring device A may receive the request message and transmit a registration message which includes both the measuring device identification number of the measuring device A and the receiving device identification number of the receiving device. The receiving device may receive such registration message from the measuring device A, and then registers the measuring device A if the registration message from registration device A includes the receiving device identification number of the receiving device. Other measuring devices may also send respective registration messages. However, if other measuring devices do not receive the request message from the receiving device, the other measuring device may not include the receiving device identification number of the receiving device into the respective registration message. Each measuring device may transmit one or more data messages, each containing the physiological parameter from the measuring device. The receiving device may receive one or more data messages from the measuring device A or from any of the other measuring devices. In one embodiment, the receiving device only processes the physiological parameter from registered measuring device by the receiving device.

In order to make sure that only the measuring device A is registered, in one embodiment, the range of the transmission of the request message between the receiving device and the measuring device A may be such that the following requirements (a) and (b) are both fulfilled only for the measuring device A but not for other measuring devices. The requirement (a) is that the measuring device is able to receive the request message, and the requirement (b) is that if the measuring device receives the request message and transmits a registration message which includes the measuring device identification number of the measuring device and the receiving device identification number of the receiving device, the receiving device is able to receive such a registration message.

To monitor the physiological parameter transmitted by the measuring device A, it may not be desirable for the receiving device to be always near the measuring device A. Accordingly, in one embodiment, after the receiving device registers the measuring device A, the receiving device may be brought farther away from the measuring device A and is still able to receive the one or more data messages from the measuring device A. In other words, the range of transmission of the request message between the receiving device and the measuring device A is shorter than the range of the transmission of the one or more data messages between the measuring device A and the receiving device. Alternatively, in one embodiment; the range of the transmission of the registration message between the measuring device A and the receiving device is shorter than the range of the transmission of the one or more data messages between the measuring device A and the receiving device. Alternatively, in one embodiment, the range of transmission of the request message between the receiving device and the measuring device A is shorter than the range of the transmission of the one or more data messages between the measuring device A and the receiving device, and the range of the transmission of the registration message between the measuring device A and the receiving device is shorter than the range of the transmission of the one or more data messages between the measuring device A and the receiving device. That is, the registration of the measuring device A by the receiving device may be done when the two devices are close enough, and after the registration is done, the receiving device may be taken farther away from the measuring device A while still being able to receive data messages transmitted by the measuring device A.

In one embodiment, the request message is transmitted by the receiving device upon an activation of the receiving device. For example, the activation may be the pressing of a button of the receiving device by a healthcare personnel such that the request message is transmitted. In a more concrete example, a healthcare personnel may hold the receiving device and come close to a measuring device A and then press the button. The request message is then transmitted. The distance is such that the measuring device A can receive the request message from the receiving device and the receiving device can receive the registration message from the measuring device A.

In one embodiment, the at least one measuring device which receives the request message is configured to generate and transmit the registration message continuously or periodically.

In an alternative embodiment, the at least one measuring device is configured to generate and transmit the registration message only if the at least one measuring device has received the request message. For example, after receiving the request message, the at least one measuring device may start to transmit one or several registration messages, or start to transmit the registration continuously or periodically after receiving the request message.

In one embodiment, the at least one measuring device is configured to transmit data messages periodically or continuously, each data message including the measuring device identification number and a physiological parameter from the at least one measuring device. The at least one measuring device may transmit data messages regardless of whether the at least one measuring device receives any request message.

In one embodiment, the at least one measuring device is configured to transmit data messages periodically or continuously only if the at least one measuring device has received the request message, wherein each data message includes the measuring device identification number and a physiological parameter from the at least one measuring device. In other words, in this embodiment, the at least one measuring device will not transmit any data message before receiving any request message from the receiving device; it will only transmit data messages periodically or continuously after the at least one measuring device receives the request message. This may be advantageous in that power is not consumed by the at least one measuring device when no receiving device intends to monitor the physiological parameter measured by the at least one measuring device.

In one embodiment, according to the method 100, the at least one measuring device generates the registration message which includes the measuring device identification number of the at least one measuring device. If the request message from the receiving device is received by the at least one measuring device, the registration message generated by the at least one measuring device also includes the receiving device identification number. According to the method 100, the at least one measuring device is configured to transmit the registration message, and the one or more data messages.

In one embodiment, the registration message is transmitted together with a data message as a single message. The registration message may include the respective measuring device identification number. If the at least one measuring device receives the request message, the registration message may also include the receiving device identification number. The data message may include the physiological parameter from the at least one measuring device and also the respective measuring device identification number. When the registration message is transmitted together with a data message as a single message, such single message may include the respective measuring device identification number and the physiological parameter from the respective measuring device. If the at least one measuring device receives the request message, the single message may further include the receiving device identification number into the single message.

In one embodiment, the request message further includes instructions on how frequently the physiological parameter is measured by the at least one measuring device, or how frequently the physiological parameter is transmitted by the at least one measuring device, or both.

In one embodiment, all measuring devices of the plurality of measuring devices, the respective registration message of each containing the receiving device identification number, are registered by the receiving device. In other words, for example, more than one measuring device of the plurality of the measuring devices may receive the request message and then transmit registration messages each including the receiving device identification number and the respective measuring device identification number. Upon receiving registration messages of the more than one measuring device, the receiving device may register all the measuring devices which includes the receiving device identification number in the respective registration message.

In one embodiment, the monitoring system comprises a plurality of receiving devices, wherein registration of the at least one measuring device, being already registered by a first receiving device of the plurality of receiving devices, by another receiving device of the plurality of receiving devices, terminates registration of the at least one measuring device by said first receiving device. In other words, for example, a receiving device A has already registered a measuring device A. Then a receiving device B may transmit a request message which is received by the measuring device A. In response to the request message from the receiving device B, the measuring device A may transmit a registration message including the measuring device identification number of the measuring device A and the receiving device identification number of the receiving device B. The receiving device A may receive the registration message which includes the registration device identification of receiving device B from the measuring device A, and the receiving device A may deregister the measuring device A in one embodiment.

In one embodiment, the monitoring system comprises a plurality of receiving devices, wherein registration of the at least one measuring device, being already registered by a first receiving device of the plurality of receiving devices, by another receiving device of the plurality of receiving device, does not affect the at least one measuring device registration by said first receiving device. In other words, for example, a receiving device A has already registered a measuring device A. Then a receiving device B may transmit a request message which is received by the measuring device A. In response to the request message from the receiving device B, the measuring device A may transmit registration message including the measuring device identification number of the measuring device A and the receiving device identification number of the receiving device B. The receiving device A may receive the registration message which includes the registration device identification of receiving device B from the measuring device A, and the reception of such registration message from the measuring device A may not effect the registration of the measuring device A by the receiving device A, i.e. the pairing of the receiving device with the at least one measuring device remains intact.

In one embodiment, the method 100 may further include, if the at least one measuring device has been registered by the receiving device, transmitting, by the receiving device, a termination message which includes instructions to the at least one measuring device to stop transmitting data messages. The method 100 may further include deregistering, by the receiving device, the at least one measuring device. For example, after the receiving device registers the at least one measuring device, and processes the one or more data messages from the registered at least one measuring device, a healthcare personnel may decide to stop monitoring the physiological parameter measured by the registered at least one measuring device, and may activate the receiving device to transmit a termination message. The termination message may include instructions to the registered at least one measuring device to stop transmitting data messages. In addition, the receiving device may deregister the registered at least one measuring device.

In one embodiment, the receiving device is configured to transmit the termination message upon being powered off. For example, upon being powered off, the receiving device may be configured to automatically transmitted the termination message.

In one embodiment, the at least one measuring device is configured to stop transmitting the data messages and registration messages upon receiving the termination message.

As mentioned earlier, for example, if there are a plurality of measuring devices in a room and it is desired that only one measuring device A of the plurality of measuring devices is registered, the combination of the selection of the transmitter for transmitting a request message by the receiving device, the receiver for receiving the request message by each measuring device, the transmitter for transmitting a registration message by each measuring device, and the receiver for receiving each registration message by the receiving device may be such that, when the receiving device is brought close to the measuring device A (e.g. the measuring device A and the receiving device are within a registration range for registering the measuring device A by the receiving device), only the measuring device A fulfills the following two conditions (a) and (b) among the plurality of measuring devices. The requirement (a) is that the measuring device is able to receive the request message, and the requirement (b) is that if the measuring device receives the request message and transmits a registration message which includes the measuring device identification number of the measuring device and the receiving device identification number of the receiving device, the receiving device is able to receive such a registration message. In this context, the registration range may be referred to as a range within which the measuring device A can be registered by the receiving device. Accordingly, on the basis of the above, a person skilled in the art would appreciate that there may be different selections or different combination of selections of the transmitter for transmitting a request message by the receiving device, the receiver for receiving the request message by each measuring device, the transmitter for transmitting a registration message by each measuring device, and the receiver for receiving each registration message by the receiving device. The selection of the transmitter for transmitting a request message by the receiving device, the receiver for receiving the request message by each measuring device, the transmitter for transmitting a registration message by each measuring device, and the receiver for receiving each registration message by the receiving device or any combination of the above described herein according to various exemplary embodiments are only for illustration purposes and are not limited thereto.

In one exemplary embodiment, the method 100 may further include transmitting, by the receiving device, the request message through a short range transmitter. For example, the short range transmitter may be a low frequency (LF) magnetic transmitter. In a further embodiment, the method 100 may further include receiving, by the at least one measuring device, the request message from the receiving device through a short range receiver. For example, the short range receiver may be an LF magnetic receiver. In one embodiment, the range of the transmission of the request message between the receiving device and the at least one measuring device is up to about 20 cm. It should be noted that the range of the transmission of the request message between the receiving device and the at least one measuring device mentioned here is only for illustration purposes and is not limited to the range given here. The actual range may depend on the requirements of the actual system implementation. For example, assuming there are a plurality of measuring device in one room, and the requirement may be that after a request message is transmitted, only one measuring device A is registered. According to this requirement, the range of the transmission of the request message between the receiving device and the measuring device A may be determined by taking into account the size of the room and the distance among the measuring devices in the room. On the basis of the range of the transmission of the request message between the receiving device and the measuring device A, the transmitter of the receiving device used to transmit the request message and the receiver of the measuring device A used to receive the request message may be determined accordingly.

Analogously, a person skilled in the art would appreciate that on the basis of the system requirements, the transmitter used by measuring device A to transmit registration messages, the transmitter used by the measuring device A to transmit data messages, and the receiver used by the receiving device to receive data messages may be determined.

In one exemplary embodiment, the method 100 may include transmitting, by the at least one measuring device, the registration message through a short range transmitter or a long range transmitter. For example, the short range transmitter may be an LF magnetic transmitter and the long range transmitter may be a radio frequency (RF) transmitter. In a further embodiment, the method 100 may include receiving, by the receiving device, the registration message through a short range receiver if the at least one measuring device is configured to transmit the registration message through a short range transmitter; or receiving, by the receiving device, the registration message through a long range receiver if the at least one measuring device is configured to transmit the registration message through a long range transmitter. For example, the short range receiver may be an LF magnetic receiver, and the long range receiver may be an RF receiver. In one embodiment, the range of the transmission of the registration message between the at least one measuring device and the receiving device is up to about 20 cm if the at least one measuring device is configured to transmit the registration message through a short range transmitter and the receiving device is configured to receive the registration message through a short range receiver. In one embodiment, the range of the transmission of the registration message between the at least one measuring device and the receiving device is at least about 5 meters if the at least one measuring device is configured to transmit the registration message through a long range transmitter and the receiving device is configured to receive the registration message through a long range receiver.

In one embodiment, the method 100 may further include transmitting, by the at least one measuring device, each data message, or the registration message and each data messages as one single message, through a long range transmitter. For example, the long range transmitter may be an RF transmitter. In a further embodiment, the method 100 may further include receiving, by the receiving device, the one or more data messages through a long range receiver. For example, the long range receiver may be an RF receiver. In one embodiment, the range of the transmission of the data message between the at least one measuring device and the receiving device is at least about 5 meters.

It is noted that the above exemplary embodiments are only for illustration purposes. The types of transmitter(s) or receiver(s) used by the receiving device and the at least one measuring device depend on the actual implementation of the system. Depending on the requirements of the actual system, there may be different combinations of the transmitter used by the receiving device to transmit the request message, the receiver used by the at least one measuring device to receive the request message, the transmitter used by the at least one measuring device to transmit the registration message, the receiver used by the receiving device to receive the registration message, the transmitter used by the at least one measuring device to transmit each data message, and the receiver used by the receiving device to receive each data message.

In one embodiment, the physiological parameter measured by the at least one measuring device is body temperature.

In one embodiment, the method 100 may further include displaying, by the receiving device, the physiological parameter in each data message if the at least one measuring device has been registered by the receiving device.

In one embodiment, the receiving device may further display the measuring device identification number together with the physiological parameter in the data message.

In one embodiment, the method 100 may further include coupling an output of the receiving device to an input of a physiological parameter monitoring device. In a further embodiment, the method 100 may further include outputting, through the output of the receiving device, one or more electrical or mechanical parameters which correspond to the physiological parameter received by the receiving device from the at least one measuring device, to the input of the physiological parameter monitoring device. In a further embodiment, the method 100 may further include receiving, through the input of the physiological parameter monitoring device, the one or more electrical or mechanical parameters by the physiological parameter monitoring device, and determining, by the physiological parameter monitoring device, a further physiological parameter which corresponds to the one or more electrical or mechanical parameters.

In one embodiment, the method 100 may further include displaying the further physiological parameter by the physiological parameter monitoring device.

In one embodiment, the one or more electrical or mechanical parameters include a resistive parameter, an electrical voltage parameter, an electrical current parameter, or a pressure parameter.

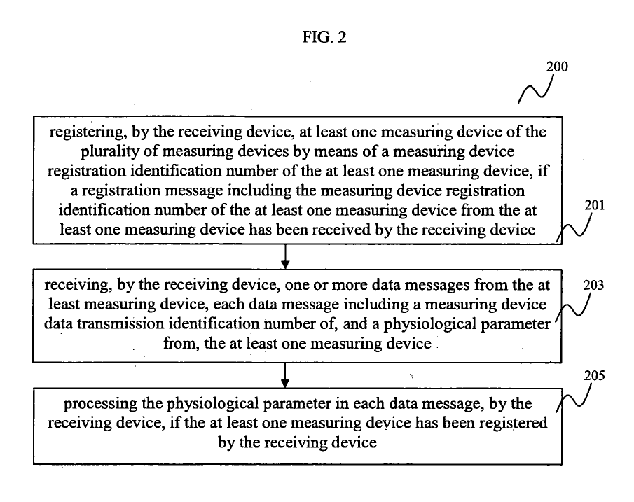

FIG. 2 shows a method 200 for monitoring a physiological parameter of a subject in accordance with another embodiment. The method 200 may be carried out by a monitoring system comprising a receiving device and a plurality of measuring devices each measuring a physiological parameter of a respective subject.

In one embodiment, the method 200 may include 201 registering, by the receiving device, at least one measuring device of the plurality of measuring devices by means of a measuring device registration identification number of the at least one measuring device, if a registration message including the measuring device registration identification number of the at least one measuring device from the at least one measuring device has been received by the receiving device. The method 200 may further include 203 receiving, by the receiving device, one or more data messages from the at least measuring device, each data message including a measuring device data transmission identification number of, and a physiological parameter from, the at least one measuring device. The method 200 may further include 205 processing the physiological parameter in each data message, by the receiving device, if the at least one measuring device has been registered by the receiving device. In one embodiment, the range of the transmission of the registration message between the at least one measuring device and the receiving device is shorter than the range of the transmission of each data message between the at least one measuring device and the receiving device.

In other words, in one embodiment, in order for a receiving device to register a measuring device A, compared with the method 100 as described herein, it may not be necessary for the receiving device to transmit a request message. For example, the measuring device A may keep transmitting registration messages which includes a measuring device registration identification number of the measuring device A. The receiving device may only be able to receive the registration message from the measuring device A when the receiving device is brought close enough to the measuring device A. For a concrete example, there may be a plurality of measuring devices in a room, and each may transmit a respective registration message. A healthcare personnel may bring a receiving device close to the measuring device A when the healthcare personnel wishes that the measuring device A is registered by the receiving device. However, the receiving device may only be able to receive a registration message if the receiving device is brought close to the respective measuring device which transmits the registration message. That is, when the healthcare personnel wishes to have the receiving device register the measuring device A and brings the receiving device close enough to the measuring device A, the receiving device only receives registration message from the measuring device A but not from other measuring devices. Upon reception of the registration message from the measuring device A, the receiving device may register the measuring device A by means of the measuring device registration identification number in the registration message from the measuring device A. After the receiving device registers the measuring device A, for example, it may be desirable that when the receiving device is brought farther from the receiving device A, the receiving device is still able to receive data message transmitted by the measuring device A. Each data message may include a physiological parameter from, and a measuring device data transmission identification number of, the respective measuring device. The receiving device may process the data message from the measuring device A if the measuring device A is registered by the receiving device. Accordingly, in one embodiment, the range of the transmission of the registration message between the measuring device A and the receiving device is shorter than the range of the transmission of the data message between the measuring device A and the receiving device. In the embodiments described in relation to FIG. 2, reception of the measuring device data transmission identification number in each data message by the receiving device may not enable the receiving device to register the measuring device which sends the data message. A receiving device which receives a data message may determine, on the basis of the measuring device data transmission identification number in the data message, whether the measuring device which transmits the data message has already been registered by the receiving device.

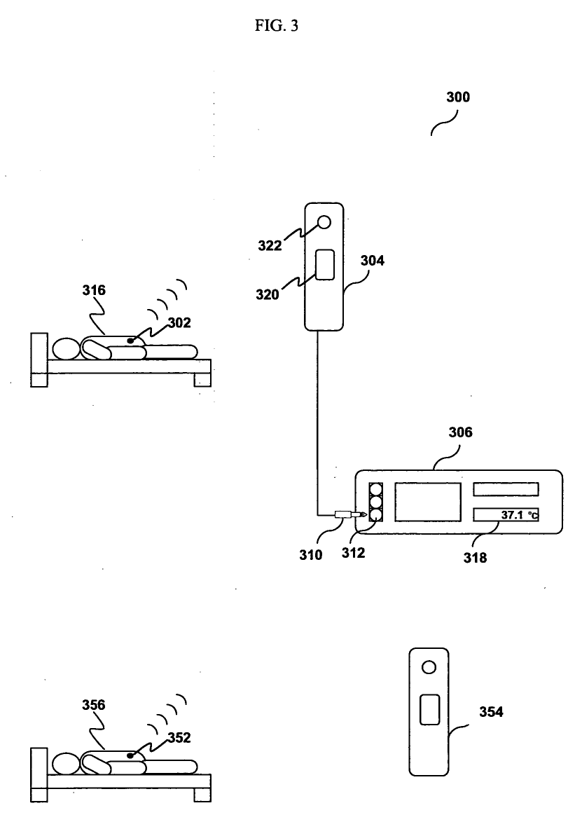

FIG. 3 shows a system 300 for monitoring a physiological parameter of at least one subject according to one embodiment. The system 300 may correspond to the method 100 as shown in FIG. 1. The at least one subject may be a patient, for example. For example, the patient may be under medical observation. In another example, the patient may be undergoing an operation. For another example, the subject may also be a sick animal which is under observation or undergoing an operation.

The system 300 may include a plurality of measuring devices 302 and 352 and a receiving device 304 according to one embodiment. A person skilled in the art would appreciate that the system 300 may include any number of measuring devices. For illustration purposes, the system 300 as shown in FIG. 3 includes 2 measuring devices 302 and 352. The measuring device 302 and the measuring device 352 may be the same except that each of them has a unique measuring device identification number. In one embodiment, the measuring device 302 may be configured to measure the physiological parameter of the subject 316. For example, the measuring device 302 may be mounted on any location on the subject 316 that is convenient for the measurement of the physiological parameter of the subject 316. The measuring device 352 may be mounted on any location on the subject 356 that is convenient for the measurement of the physiological parameter of the subject 356. In one example, the physiological parameter may be body temperature and the measuring devices 302 and 352 may be mounted on the abdomen of the respective patients.

In one embodiment, the receiving device 304 is configured to transmit a request message which includes a receiving device identification number of the receiving device 304. In one embodiment, the receiving device 304 is further configured to receive a registration message from at least one measuring device of the plurality of measuring devices. For illustration purposes, it is assumed that the receiving device 304 receives a registration message from the measuring device 302, for example. The registration message from the measuring device 302 may include a measuring device identification number of the measuring device 302. In one embodiment, the receiving device 304 is further configured to register the measuring device 302 by means of the measuring device identification number of the measuring device 302 if the registration message from the measuring device 302 includes the receiving device identification number of the receiving device 304. In one embodiment, the receiving device 304 is further configured to receive one or more data messages from the measuring device 302, wherein each data message includes the measuring device identification number of, and a physiological parameter from, the measuring device 302. In one embodiment, the receiving device 304 is further configured to process the physiological parameter in each data message from the measuring device 302, if the measuring device 302 has been registered by the receiving device 304. In one embodiment, the range of the transmission of the request message between the receiving device 304 and the measuring device 302 is shorter than the range of the transmission of each data message between the measuring device 302 and the receiving device 304, and/or the range of the transmission of the registration message between the measuring device 302 and the receiving device 304 is shorter than the range of the transmission of each data message between the measuring device 302 and the receiving device 304.

In one embodiment, the receiving device is configured to transmit the request message upon an activation of the receiving device. In one example, the receiving device 304 may be held by a healthcare personnel. When the healthcare personnel wishes to obtain the physiological parameter measured by the measuring device 302, the healthcare personnel may initiate the receiving device 304 to transmit the request message. For example, the healthcare personnel may press a button 322 on the receiving device 304 to initiate the receiving device 304 to transmit the request message.

In one embodiment, the measuring device 302 is configured to generate and transmit the registration message continuously or periodically. In one exemplary embodiment, the measuring device 302 may be configured to transmit the registration message irrespective of whether the measuring device 302 has received a request message from any receiving device. If the measuring device 302 has not received any request message from the receiving device 304, the measuring device may include the measuring device identification number of the measuring device 302 into the registration message of the measuring device 302.

In an alternative embodiment, the measuring device 302 is configured to generate and transmit the registration message only if the measuring device 302 has received a request message. For example, the measuring device 302 may start to transmit one or a few registration messages after receiving the request message. For another example, the measuring device 302 may start to transmit registration messages periodically or continuously after the measuring device 302 receives the request message.

In one embodiment, the measuring device 302 is configured to transmit data messages periodically or continuously. Each data message may include the measuring device identification number of the measuring device 302 and a physiological parameter from the measuring device 302. The measuring device 302 may be configured to transmit data messages irrespective of whether the measuring device 302 receives any request message.

In an alternative embodiment, the measuring device 302 is configured to transmit data messages periodically or continuously only if the measuring device 302 has received a request message, wherein each data message includes the measuring device identification number and a physiological parameter from the measuring device 302.

In one embodiment, the measuring device 302 is configured to generate a registration message including the measuring device identification number of the measuring device 302. If the request message from the receiving device 304 is received by the measuring device 302, the registration message generated by the measuring device 302 further includes the receiving device identification number of the receiving device 304. In one embodiment, the measuring device 302 is configured to transmit the registration message and the one or more data messages.

In one embodiment, the registration message and each data message are transmitted as one single message by the measuring device 302. For example, such a single message may include the measuring device identification number of, and the physiological parameter from, the measuring device 302. If the measuring device 302 has received the request message from the receiving device 304, such single message may further include the receiving device identification number of the receiving device 304.

In one embodiment, the request message from the receiving device 304 further includes instructions on how frequently the physiological parameter is measured by the at least one measuring device, or how frequently the physiological parameter is transmitted by the at least one measuring device, or both. The measuring device 302 may, upon receiving the request message, follow the instructions in the request message.

In one embodiment, all measuring devices of the plurality of measuring devices, the respective registration message of each containing the receiving device identification number, are registered by the receiving device 304. For example, both the measuring devices 302 and 352 may receive the request message from the receiving device 304, and both measuring devices 302 and 352 may each transmit a respective registration message including the respective measuring device identification number and the receiving device identification number of the receiving device 304. The receiving device 304, upon receiving the registrations messages from both measuring devices 302 and 352, may register both measuring devices 302 and 352. It is appreciated that in one scenario, the measuring device 302 and the measuring device 352 may receive the same request message from the receiving device 304 and each of the measuring devices 302 and 352 may transmit a registration message respectively in response to the request message. In another scenario, the receiving device 304 may first transmit a first request message, which is received by the measuring device 302 only. Accordingly, the measuring device 302 may transmit a registration message including the measuring device identification number of the measuring device 302 and the receiving device identification number of the receiving device 304. The receiving device 304, upon receiving the registration message from the measuring device 302, may register the measuring device 302. The receiving device 304 may be then brought close to the measuring device 352 and transmit a second request message. The measuring device 352 may receive the second request message and transmit a registration message including the measuring device identification number of the measuring device 352 and the receiving device identification number of the receiving device 304. The receiving device 304 may register the measuring device 352 upon receiving the registration message from the measuring device 352.

In one embodiment, the system 300 may include a plurality of receiving devices. It is understood that the system 300 may include any number of receiving devices. For illustration purposes, the system 300 includes 2 receiving devices 304 and 354. The receiving device 304 and the receiving device 354 may be the same except that each has a unique receiving device identification number.

In one exemplary embodiment, registration of the measuring device 352, being already registered by a receiving device 304 of the plurality of receiving devices, by another receiving device 354 of the plurality of receiving devices terminates registration of the measuring device 352 by the receiving device 304. For example, the measuring device 352 may have been registered by the receiving device 304. Later another receiving device 354 is brought close to the measuring device 352 and transmits a request message. The measuring device 352 may receive the request message from the receiving device 354 and then transmit a registration message including the measuring device identification number of the measuring device 352 and the receiving device identification number of the receiving device 354. The receiving device 304 may receive such a registration message from the measuring device 352, and may deregister the measuring device 352. For example, the receiving device 304 may deregister the measuring device 352 when the receiving device 304 determines that the registration message from the measuring device 352 includes a receiving device identification number that is different from that of the receiving device 304.

In an alternative exemplary embodiment, registration of the measuring device 352, being already registered by the receiving device 304 of the plurality of receiving devices, by another receiving device 354 of the plurality of receiving devices does not affect the measuring device 352 registration by the receiving device 304. For example, the measuring device 352 may have been registered by the receiving device 304. Later another receiving device 354 is brought close to the measuring device 352 and transmits a request message. The measuring device 352 may receive the request message from the receiving device 354 and then transmit a registration message including the measuring device identification number of the measuring device 352 and the receiving device identification number of the receiving device 354. The receiving device 304 may receive such a registration message from the measuring device 352, and may maintain the registration of the measuring device 352.

In one embodiment, if the measuring device 302 has been registered by the receiving device 304, the receiving device 304 is configured to transmit a termination message including instructions to the measuring device 302 to stop transmitting data messages and registration messages. The receiving device 304 may be further configured to deregister the measuring device 302. In one embodiment, the receiving device is configured to transmit the termination message upon being powered off. In one embodiment, the measuring device 302 is configured to stop transmitting the data messages and registration messages upon receiving the termination message.

In one exemplary embodiment, the receiving device 304 is configured to transmit the request message through a short range transmitter. For example, the short range transmitter may be an LF magnetic transmitter. LF magnetic transmission is a useful and viable wireless alternative to radio frequency. An LF magnetic transmitter is generally not suited for long range applications but is advantageous for use in applications where a short but well-controlled range is required. The common range of frequencies to use may be, for example, from 50 kHz to 150 kHz. Both the LF transmitter and the LF receiver are very low-cost to implement. In one embodiment, the LF transmitter may be implemented using a serial resonant tank circuit that is tuned to 125 kHz. A Manchester coding scheme may be used for data formatting and transmission. In a further embodiment, the measuring device 302 is configured to receive the request message through a short range receiver. For example, the short range receiver may be an LF magnetic receiver. In one embodiment, the range of the transmission of the request message between the receiving device 304 and the measuring device 302 is up to about 20 cm.

In one exemplary embodiment, the measuring device 302 is configured to transmit the registration message through a short range transmitter or a long range transmitter. For example, the short range transmitter is an LF magnetic transmitter, and the long range transmitter is an RF transmitter. An LF magnetic receiver may be implemented by a combination of an LC (inductance and capacitance) tank circuit that is tuned to 125 kHz and an envelope detection circuit. These circuits may be implemented very cost effectively using discrete passive components. A sensitive comparator or op-amp circuit may be further implemented to improve the sensitivity of the receiver. Suitable frequencies to use for the RF transmitter may be the license-free ISM bands of 433 MHz, 800-900 MHz, and 2400 MHz. Various commercially available low power RF integrated circuits (RFICs) may be used to implement a cost effective RF transmitter at these frequencies. The data transmission may be in digital format. Modulation schemes such as GFSK (gaussian frequency-shift keying) may be used. In one embodiment, the transmission range of the RF transmitter is at least about 5 meters.

In a further embodiment, the receiving device 304 is configured to receive the registration message through a short range receiver if the measuring device 302 is configured to transmit the registration message through a short range transmitter, and the receiving device 304 is configured to receive the registration message through a long range receiver if the measuring device 302 is configured to transmit the registration message through a long range transmitter. For example, the short range receiver is an LF magnetic receiver and the long range receiver is an RF receiver. Suitable frequencies to use for an RF receiver may be the license-free ISM bands of 433 MHz, 800-900 MHz, and 2400 MHz. Various commercially available low power RFICs may be used to implement a cost effective RF receiver at these frequencies. In one embodiment, the range of the transmission of the registration message between the measuring device 302 and the receiving device 304 is up to about 20 cm if the measuring device 302 is configured to transmit the registration message through a short range transmitter and the receiving device 304 is configured to receive the registration message through a short range receiver, and the range of the transmission of the registration message between the measuring device 302 and the receiving device 304 is at least about 5 meters if the measuring device 302 is configured to transmit the registration message through a long range transmitter and the receiving device 304 is configured to receive the registration message through a long range receiver.

In one embodiment, the measuring device 302 is configured to transmit each data message, or the registration message and each data message as one single message, through a long range transmitter. For example, the long range transmitter is an RF transmitter. In a further embodiment, the receiving device 304 is configured to receive each data message or each single message through a long range receiver. For example, the long range receiver is an RF receiver. In one embodiment, the range of the transmission of the data message between the measuring device 302 and the receiving device 304 is at least about 5 meters.

In one embodiment, the physiological parameter measured by the measuring devices 302 and 352 is body temperature. For example, the measuring device 302 may be mounted on the subject 316 to monitor the body temperature of the subject 316. It should be understood that the measuring device 302 may also be configured to detect other physiological parameters of the subject 316. For example, the other physiological parameters may include, but are not limited to, blood pressure, heart rate, SpO2, and NIBP.

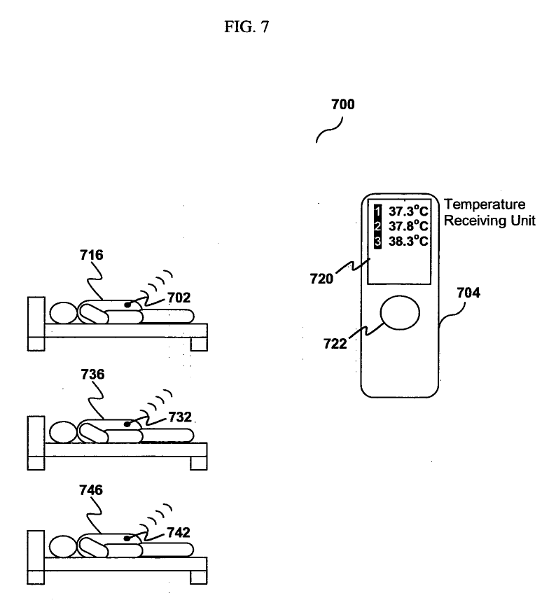

In one embodiment, the receiving device 304 is further configured to display the physiological parameter in the data message from the measuring device 302 if the measuring device 302 has been registered by the receiving device 304. In a further embodiment, the receiving device 304 is further configured to display the measuring device identification number of the measuring device 302 together with the physiological parameter in the data message from the measuring device 302. This embodiment is further illustrated in FIG. 7.

In one embodiment, the system 300 further includes a physiological parameter monitoring device 306 configured to be coupled to an output 310 of the receiving device 304.

The physiological parameter monitoring device 306 may be a multi physiological parameter monitoring device capable of monitoring multiple different physiological parameters of a subject, e.g. a patient. In this context, the multi physiological parameter monitoring device may refer to a general measuring device that is capable of monitoring more than one physiological parameter of a subject, e.g. a patient. The multi physiological parameter monitoring device 306 may include several inputs which may each be coupled to a respective measuring cable or probe. For example, the physiological parameter monitoring device 306 may include an input 312 traditionally configured to be coupled to a cable or probe for detecting the body temperature of a patient. The cable or probe may have one end in touch with the patient and the resistance of the cable or probe may change in accordance with the body temperature of the patient. The physiological parameter monitoring device 306 may detect through the input 312 the input resistance of the cable or probe and determine the value of the body temperature of the patient which corresponds to the input resistance. Similarly, the physiological parameter monitoring device 306 may further include other inputs for measurement of other physiological parameters such as SpO2 and NW.

For example, the output 310 of the receiving device 304 may be plugged into the input 312 of the physiological parameter monitoring device 306.

In one embodiment, the receiving device 304 may be configured to output, through the output 310 of the receiving device 304, one or more electrical or mechanical parameters which correspond to the physiological parameter received by the receiving device 304 from the measuring device 302, to the input 312 of the physiological parameter monitoring device 306. In one embodiment, the physiological parameter monitoring device 306 is configured to receive, through the input 312 of the physiological parameter monitoring device 306, the one or more electrical or mechanical parameters, and to determine a further physiological parameter which corresponds to the one or more electrical or mechanical parameters.

The one or more electrical or mechanical parameters that are output by the receiving device 304 may be simulated by using a set of digital potentiometers. In one embodiment, the one or more electrical or mechanical parameters may be a resistive parameter, an electrical voltage parameter, an electrical current parameter, or a pressure parameter. For example, the receiving device 304 may output a resistive parameter that corresponds to the physiological parameter (e.g. body temperature) received from the measuring device 302. The receiving device 304 may thus mimic itself to be a resistive-type sensor or probe and may make the physiological parameter monitoring device 306 ‘believe’ that a resistive-type sensor or probe is connected to the input 312 of the physiological parameter monitoring device 306. The receiving device 304 may program the digital potentiometers so that the resistive output 310 may be representative of the physiological parameter received from the measuring device 302. The receiving device 304 may determine the resistive parameter according to a look-up table or an algorithm, for example.

For illustration purposes, the physiological parameter is assumed to be patient temperature (body temperature of a patient), for example. The output 310 of the receiving device 304 may be coupled to the temperature input 312 of the physiological parameter monitoring device 306. The physiological parameter monitoring device 306 in normal operation may be expecting a temperature probe with a pre-determined temperature-resistance characteristics to be coupled to this input. The look-up table or algorithm in the receiving device 304 may be thus configured to match this temperature-resistance characteristics. The physiological parameter monitoring device 306 may determine the patient temperature by converting resistance at the input 312 to a temperature value. The patient temperature so determined by the physiological parameter monitoring device 306 may be slightly different from the temperature measured by the measuring device 302 due to systematic errors. For example, systematic errors may be caused by the possible slight difference between the real resistive parameter output from the output 310 and the determined resistive parameter to be output by the receiving device 304.

It is appreciated that the measuring device 302 may be mounted to any location on the subject 316 that is suitable for the measurement of the respective physiological parameter. For example, referring to FIG. 3, the measuring device 302 may be mounted on a patient at a suitable location for carrying out the measurement of heart rate, e.g. in a body area near the heart of the patient. The measuring device 302 may transmit one or more data messages after receiving a request message from the receiving device 304. Each data message may include the most recently measured heart rate of the patient. The receiving device 304 may display the received heart rate from the measuring device 302 on the display of the receiving device 304 if the receiving device 304 is not connected to the physiological parameter monitoring device 306 but is carried by a healthcare personnel. Alternatively, the receiving device 304 may be connected to the physiological parameter monitoring device 306. The receiving device 304 may, for example, determine a resistive parameter at the output 310 according to a look-up table. The look-up table may provide the correspondence of the value of heart rate with the value of resistance. The physiological parameter measuring device 306 may determine a further heart rate from the input resistive parameter at the input 312. Alternatively, the receiving device 304 may determine another parameter, e.g. one or more electrical or mechanical parameters, other than the resistive parameter at the output 310 that corresponds to the physiological parameter received from the measuring device 302. For example, the one or more electrical or mechanical parameters may be detected by an input of the physiological parameter monitoring device 306 wherein the input is configured to be coupled to a probe for detecting the heart rate of the patient. It is appreciated that the one or more electrical or mechanical parameters may not necessarily be the resistive parameter but may be any other electrical or mechanical parameters that can be detected by the physiological parameter monitoring device 306. The other electrical or mechanical parameters that may be output from the output 310 may include, but are not limited to a current parameter and a voltage parameter. The physiological parameter monitoring device 306 may further display the further heart rate on the display 318, for example.

Examples of other possible physiological parameters that may be measured using the system as shown in FIG. 3 may further include, but are not limited to, SpO2 (saturation of peripheral oxygen) and NIBP (non-invasive blood pressure).

In one example, the system 300 as shown in FIG. 3 may be configured to measure the SpO2 of the patient 316. Traditionally, a pulse oximeter which is used to measure the SpO2 may include a pair of LEDs facing a light sensitive detector. One LED may emit red light while the other LED may emit infrared, and the light sensitive detector may be an analog component such as a photodiode or phototransistor. The pulse oximeter may be connected to the physiological parameter monitoring device 306 by a cable. The pulse oximeter may be attached to the extremities of the patient 316 such as fingers and ear lobes. Taking the finger as an example as the location where the pulse oximeter is mounted, the finger may be between the LEDs and the light sensitive detector of the pulse oximeter. The light sensitive detector may measure the absorption of the red light and infrared emitted by the two LEDs respectively, and output electrical or mechanical parameters such as a voltage output or a current output which may be relayed back to the physiological parameter monitoring device 316 through the cable. The ratio of the absorption of the two light sources (two LEDs) may then be used by the physiological parameter monitoring device 306 to calculate the value of the SpO2. In addition, the variation in absorption may also be used to measure the pulse rate. In one embodiment, the measuring device 302 as shown in FIG. 3 may include a pulse oximeter, and may be configured to measure SpO2 and pulse rate. The measuring device 302 may be further configured to transmit wirelessly the measured results to the receiving device 304 upon receiving a request message from the receiving device 304. The receiving device 304 may then output one or more electrical or mechanical parameters such as a voltage parameter or a current parameter which corresponds to the received measurements results from the measuring device 302, through the output 310 of the receiving device 304. The output 310 may be coupled to the input 312 of the physiological parameter monitoring device 306 and, the physiological parameter monitoring device 306 may receive the voltage or current parameter from the input 312 and determine the corresponding SpO2 and pulse rate. The physiological parameter measuring device 306 may further display the determined SpO2 and pulse rate on the display 318. Thus, as described above, the relaying cable traditionally used between the physiological parameter monitoring device and the pulse oximeter may be eliminated according to one embodiment.

For another example, the system 300 as shown in FIG. 3 may be used to measure the physiological parameter of NIBP. Traditionally an arm cuff may be attached to a physiological parameter monitoring device using a flexible tube to measure the NIBP. The physiological parameter monitoring device 106 may pump in air through the tube into the cuff and the pressure of the cuff is measured by the physiological parameter monitoring device 306. The variation of the cuff pressure may be used to calculate the blood pressure and pulse rate of the patient. In one embodiment, the measuring device 302 as shown in FIG. 3 may be configured to measure the NIBP of the patient 316. The measuring device 302 may transmit wirelessly the measurement results to the receiving device 304. The receiving device 304 may then output the pressure variations which correspond to the received results for the measuring device from the output 310 of the receiving device 304. The output 310 may be coupled to the input 312 of the physiological parameter monitoring device 306. The physiological parameter monitoring device 306 may receive the pressure from the input 312 and determine the corresponding blood pressure and pulse rate. The physiological parameter monitoring device 306 may be further configured to display the blood pressure and pulse rate on the display 318. As can be seen, the connection of flexible tube traditionally used between the physiological parameter monitoring device and arm cuff may be eliminated according to the embodiment described herein.

In one embodiment, the physiological parameter monitoring device 306 is configured to display the further physiological parameter. For example, the physiological parameter monitoring device 306 may display the further physiological parameter on the display 318.

In one embodiment, the receiving device 304 may further include an LED 320 configured to indicate that the receiving device 304 is on or to indicate that the receiving device 304 is receiving a registration message and/or a data message.

In one embodiment, the one or more electrical or mechanical parameters include a resistive parameter, an electrical voltage parameter, an electrical current parameter, or a pressure parameter.

Each measuring device may randomize the transmission times of its registration message and data message to avoid collision of transmissions with other measuring devices according to one embodiment.

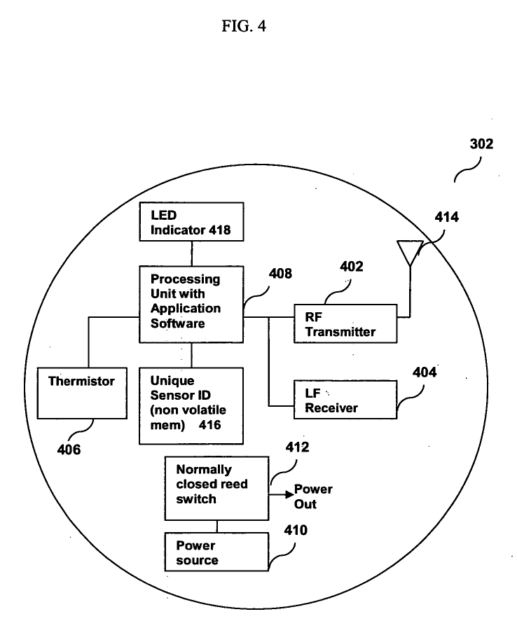

FIG. 4 illustrates a block diagram of the measuring device 302 as shown in FIG. 3 in detail according to one exemplary embodiment.

As described earlier, the measuring device 302 may be mounted on the subject 316 and monitor a physiological parameter, e.g. body temperature, of the subject 316. The measuring device 302 may transmit the measured physiological parameter periodically upon receiving a request message.

The measuring device 302 may include an LF magnetic receiver 404 in one exemplary embodiment. The LF magnetic receiver 404 may be configured to receive a request message from the receiving device 404 as shown in FIG. 3.

The measuring device 302 may further include an RF transmitter 402 in one embodiment. The RF transmitter 402 may be configured to transmit each registration massage and each data message. The RF transmitter may be a long range transmitter. The RF transmitter may be coupled to an antenna 414 for transmission of each registration message and each data message.

In the scenario that the measuring device 302 is configured to measure the body temperature of a patient, the measuring device 302 may further include a thermistor 406. Generally speaking, a thermistor is a type of resistor whose resistance varies with temperature and may be used as a temperature sensor. The thermistor 406 may be configured to measure the temperature of the subject 316 as shown in FIG. 3. It is appreciated that in the scenario that the measuring device 302 is configured to measure other physiological parameters such as heart rate, another type of sensor may be used that is suitable for measuring heart rate. The sensor used in the measuring device 302 depends on the type of physiological parameter that the measuring device is configured to measure. A person skilled in the art would understand that it might also be the case that the measuring device 302 is configured to monitor more than one physiological parameter and thus include more than one type of sensor.

The measuring device 302 may further include a processing unit 408. The processing unit 408 may be configured to process a request message received through the LF receiver 404. The processing unit 408 may also be configured to generate a registration message in response to the request message and each data message. For example, the processing unit 408 may include the measuring device identification number of the measuring device 302 in each registration message and each data message. The processing unit 408 may also include the physiological parameter that the measuring device 302 detects most recently in each message. The processing unit 408 may also include the receiving device identification number of the receiving device 304 in the registration message if the measuring device 302 has received the request message from the receiving device 304 according to one embodiment.

The measuring device 302 may be mounted on a suitable body site of the subject 316 as shown in FIG. 3 using a 2-layer hypoallergenic medical tape system. The first layer of hypoallergenic tape may be firstly applied to the body site where the measuring device 302 is to be mounted. The measuring device 302 may be then placed onto the first layer of tape. This may prevent direct contact between the measuring device 302 and the skin of the patient. Then the second layer of hypoallergenic tape may be applied onto the measuring device 302 so that the measuring device 302 is secured to the body site. For example, when the measuring device 302 is configured to measure body temperature of a patient, the measuring device 302 may be mounted close to the iliac or femoral artery of the patient using the procedure described above. The measuring device 302 may have a unique measuring device identification number. The housing of the measuring device 302 may have a transparent window on the top face to visually expose a barcode label pasted on the inside of the top face. The barcode label may be encoded with the measuring device identification number. In one embodiment, a passive RFID label may be embedded within the measuring device housing. The passive RFID may also be encoded with the measuring device ID according to one embodiment.

The measuring device 302 may further include a memory 416. The memory may be non-volatile type memory, for example. The memory 416 may be used to store the measuring device identification number of the measuring device 302. The memory 416 may be used to further store the receiving device identification number contained in a received request message. The memory 416 may also be used to store the physiological parameter that the measuring device 302 detects each time or only the physiological parameter that the measuring device 302 detects most recently.

The measuring device 302 may further include a power source 410. For example, the power source 410 may be a coin cell battery.

In one embodiment, the measuring device 302 may further include a power management unit 412. The power management unit 412 may be used to power on or power off the power supply to the measuring device circuits.

In one embodiment the power management unit 412 may include a normally closed reed switch coupled between the coin cell battery and the measuring device circuit. An example of the normally closed reed switch is the R-5B-S reed sensor from RRE India limited. The normally closed reed switch may open in the presence of a magnetic field of appropriate strength. For example, when the measuring device 302 is returned to a storage shell or case with an embedded magnet appropriately positioned, the reed switch may be opened and the battery may be disconnected from the circuit. This may be useful in conserving battery life when the measuring device 302 is put to long-term storage, being transported, or not in use. The measuring device 302 may be powered up once the measuring device 302 is removed from the storage shell or case.

In another embodiment, a tape with an embedded magnet may be removed from or applied to the measuring device to power on or off the measuring device 302.

When the measuring device 302 is powered on, the measuring device 302 may periodically measure a physiological parameter, e.g. temperature. The measuring device 302 may transmit over the RF transmitter 402 its device identification number and the measured physiological parameter in each data message. In response to a request message from a receiving device, that is received over the short range LF method of communication (e.g. through the LF magnetic receiver 404), the measuring device 404 may transmit over the RF transmitter 402 a registration message that consists of the measuring device identification number and the receiving device identification number of the receiving device that sent the request message.

In one embodiment, the measuring device 302 may further include an LED indicator 418. The LED indicator 418 may be used to indicate that the measuring device 302 is powered on or to indicate that the measuring device 302 is processing a message or performing another task.

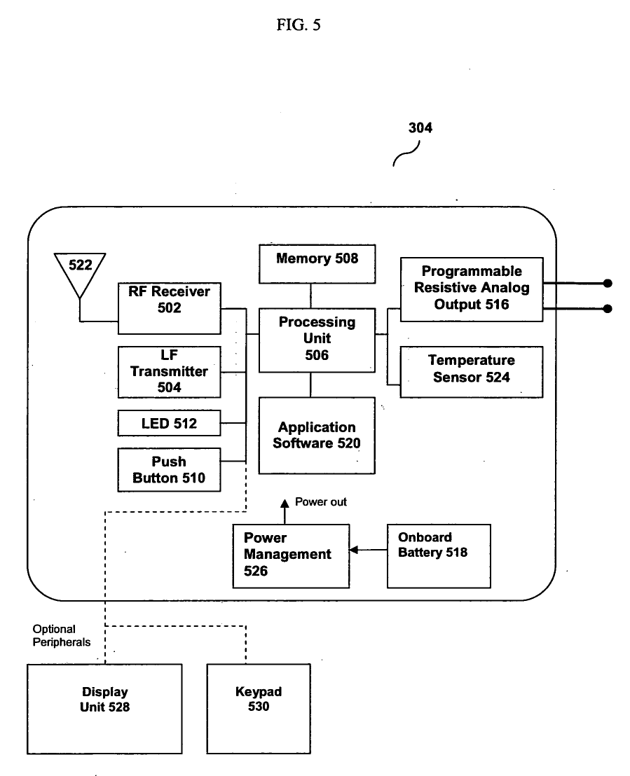

FIG. 5 shows the block diagram of the receiving device 304 as shown in FIG. 3 in more detail according to one exemplary embodiment.

The receiving device 304 may include a LF transmitter 504 configured to transmit a request message. The LF transmitter 504 may be a short range transmitter.

The receiving device 304 may further include a RF receiver 502 configured to receive a reply message from the measuring device. The RF receiver 502 may be a long range receiver. The RF receiver 502 may be coupled to an antenna 522 for receiving the reply message.

The receiving device 304 may further include a processing unit 506. The processing unit 506 may be configured to process a registration message and to process each data message if the processing unit 506 determines that the received data message is transmitted by a registered measuring device 304. The processing unit 506 may also be configured to determine a resistance parameter that corresponds to the physiological parameter contained in the received reply message to output from an output 516 of the receiving device 304. The output 516 corresponds to the output 310 as shown in FIG. 3.

The receiving device 304 may further include a memory 508. The memory 508 may be used to store the receiving device identification number of the receiving device 304. The memory 508 may also be used to store the measuring device identification number(s) of the measuring device(s) registered by the receiving device 304. The memory 508 may also be used to store the physiological parameter contained in each data message transmitted by each registered measuring device.

The receiving device 304 may further include a button 510. For example, a healthcare personnel carrying the receiving device 304 may press the button 510 to initiate the receiving device 304 to transmit a request message. The button 510 corresponds to the button 322 in FIG. 3.

The receiving device 304 may further include an LED indicator 512. For example, the LED indicator 512 may be used to indicate that the receiving device 304 is on. The LED indicator 512 may also be used to indicate that the receiving device 304 is receiving a registration message or a data message.

The receiving device 304 may further include a buzzer (not shown). The buzzer may be used to indicate whether a successful registration with a measuring device is made. For example the receiving device may beep once upon successful registration, and may beep twice when a registration fails.

The receiving device 304 may further include an output 516. The output 516 may be a programmable resistive analog output. The output 516 may be configured to output a resistance parameter which corresponds to the physiological parameter contained in a data message that the receiving device 304 received.

The receiving device 304 may further include a power source 518. The power source 518 may be an internal battery for example.

The receiving device 304 may further include a power management unit 526. The power management unit 526 may have a similar working mechanism as the power management unit 412 as shown in FIG. 4. The power management unit 526 may be configured to turn the power of the receiving device circuits on or off. The power management unit 526 may further include a battery charging circuit for the case where rechargeable batteries are used.

The receiving device 304 may optionally include a display 528. The display 528 may be used to display the physiological parameter contained in the reply message, for example.

The receiving device 304 may further include a keypad 530. The keypad 530 may be used to set the physiological parameter to be displayed on the display 528. The keypad 530 may also be used to set the display mode or measurement unit. For example if the physiological parameter is temperature, the keypad 530 may allow the user to set the measurement unit to either Celsius or Fahrenheit.

The receiving device 304 may further include application software 520. The application software may be used by the processing unit 506 to determine a resistance parameter that corresponds to the physiological parameter contained in a data message to be output from the output 516. The software 520 may contain an algorithm or a look-up table. Optionally, the application software 520 may be stored in the memory 508.

The LF transmitter 504 may be used for sending a request message to a measuring device. In one scenario, the measuring device may be first mounted on a patient by a healthcare personnel. The healthcare personnel may later bring the receiving device 304 into proximity (e.g. about 20 cm) to the measuring device. The healthcare personnel may push the button 510 to initiate transmission of a request message through the LF transmitter 504. The measuring device may reply with a registration message. The registration message may include the measuring device identification number and the receiving device identification number of the receiving device 304. The registration message may be transmitted together with a data message as one single message which further includes the physiological parameter that the measuring device measured most recently.

In one embodiment, the processing unit 506 of the receiving device 304 may register the measuring device identification number contained in the registration message. In one embodiment, the processing unit 506 may filter out undesired registration messages that does not include the receiving device identification number of the receiving device 304. The processing unit 506 may not process the physiological parameter in a data message if the data message is not transmitted by a measuring device registered by the receiving device 304. In one embodiment, if a registration message contains a receiving device identification number that is different from the receiving device identification number of the receiving device 304, and a measuring device identification number that has been registered by the receiving device 304, the processing unit 506 may maintain the registration of the registered measuring device that sent the registration message. In an alternative embodiment, if the reply message contains a receiving device identification number that is different from the receiving device identification number of the receiving device 304, and a measuring device identification number that has been registered by receiving device 304, the processing unit 506 may deregister this measuring device.

The processing of each data message by the processing unit 506 may include obtaining the physiological parameter contained in each data message. The processing may also include determination of a resistance parameter that corresponds to the physiological parameter contained in each data message. The processing may also include displaying the physiological parameter by the receiving device 304.

In one embodiment, the output 516 of the receiving device 304 may be directly plugged into a conventional multi physiological parameter measuring device (patient monitor) that accepts a resistive probe, e.g. a resistive temperature probe. This embodiment may enable the receiving device 304 to emulate the performance of a conventional resistive temperature probe, and make the patient monitor display the physiological parameter received by the receiving device 304.

In one embodiment, upon receiving a data message from a measuring device, the processing unit 506 of the receiving device 304 may determine whether the measuring device which transmitted the data message has been registered by the receiving device 304 and the processing unit 506 may further process the physiological parameter in the data message if the measuring device which transmitted the data message has been registered. If the measuring device that transmitted the data message has been registered by the receiving device 304, the processing unit 506 may program the resistive analog output 516 according to the physiological parameter contained in the reply message. The resistive analog output 516 may be emulated by using digital potentiometers, FETs (field effect transistors), BJTs (bipolar junction transistors), or a combination of these.

The programmable resistive analog output 516 in the receiving device 304 may contain a resistance emulation circuit. This circuit has a non-zero temperature coefficient in practice. The temperature coefficient may be empirically determined or derived from the temperature coefficient data of the components constituting the resistance emulation circuit. An on-board temperature measuring device 524 may be included in the receiving device 304 for sensing the circuit temperature. The processing unit 506 may include an algorithm to compute the resistance to be emulated that correspond to the measured physiological parameter, for example patient temperature, that is received from the measuring device 302. An example of calculation of the resistance to be emulated is given below.

In the following, t_{coeff} is the temperature coefficient of the resistance of the emulation circuit in K⁻¹; T_{circuit} the circuit temperature of the receiving device in K; and Tₚₐₜᵢₑₙₜ is the patient temperature indicated by the measuring device in K. In this context, K stands for Kelvin, which is a widely used measurement unit for temperature, and Ω stands for ohm, which is a widely used measurement unit for electrical resistance.

The following Steinhart-Hart equation may be used as a model of the resistance of a semiconductor at different temperatures:

$$\frac{1}{T} = A + B ln R + {C ( ln R )}^{3}$$

where T is the absolute temperature of the thermistor in K; R is the resistance of the thermistor in Ω at temperature T; and A, B and C are the Steinhart-Hart coefficients. This model is also adopted by standard NTC-based thermistor probes such as the commonly used YSI 400.

Thus, given a patient temperature Tₚₐₜᵢₑₙₜ, the resistance to be emulated may be given by the inverse of the Steinhart-Hart equation:

$$R ( {T}_{patient} ) = exp ( \sqrt[3]{x - \frac{y}{2}} - \sqrt[3]{x + \frac{y}{2}} ) \\ where , \\ y = ( \frac{A - \frac{1}{{T}_{patient}}}{C} ) x = \sqrt{{( \frac{B}{3 C} )}^{3} + ( \frac{{y}^{2}}{4} )} \qquad ( 1 )$$

The processing unit 506 may determine the R(Tₚₐₜᵢₑₙₜ) according to the above equation (1) or by a look-up table. The processing unit 506 may further implement a compensation algorithm to compensate for the effects of temperature on the emulation circuit. The compensated resistance to be emulated is determined by

$${R ( {T}_{patient} )}_{compensated} = \frac{R ( {T}_{patient} )}{1 + {t}_{coeff} [ {T}_{circuit} - 273 ]} \qquad ( 2 )$$

The processing unit 506 may then program the digital potentiometers accordingly. The temperature coefficient of resistance of the emulation circuit t_{coeff} is a characteristic of the circuit. This coefficient may be determined empirically, or it may be derived from the temperature coefficient data of the components of the circuit if such data are available. The temperature of the emulation circuit T_{circuit} may be sensed by a temperature sensor built into the emulation circuit.

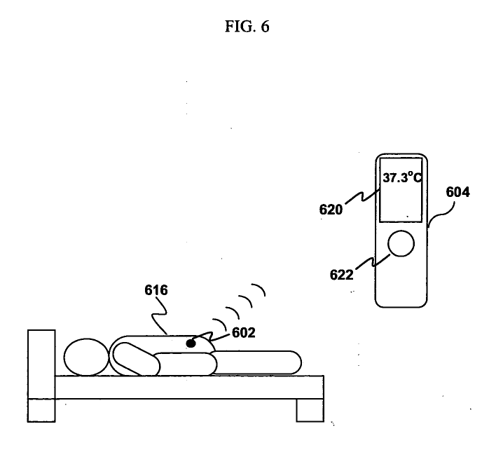

FIG. 6 illustrates the registration of a measuring device 602 by a receiving device 604 in one embodiment.

The description of the system 300 described in relation to FIG. 3 may include the physiological parameter monitoring device 306, and the output 310 of the receiving device 304 may be coupled to the input 312 of the physiological parameter monitoring device 306. It is appreciated that the receiving device 304 may be used without being connected to the physiological parameter monitoring device. For example, in FIG. 6, the receiving device 604 may be the same as the receiving device 304. The receiving device 604 may include a display 620 and the receiving device 604 may not be connected to a physiological parameter monitoring device. The measuring device 602 may be the same as the measuring device 302 as described herein. As can be seen, the measuring device 602 is mounted on the subject 616. For example, a healthcare personnel may bring the receiving device 604 and wish to obtain the physiological parameter detected by the measuring device 602. The healthcare personnel may bring the receiving device 604 in proximity to the measuring device 602 so that the measuring device 602 is capable of receiving messages sent from the receiving device 604. The healthcare personnel may press the button 622 on the receiving device 604 to initiate the receiving device 604 to transmit a request message. The request message may include the receiving device identification number of the receiving device 604. The measuring device 602 may send a registration message after receiving the request message. The registration message may include the measuring device identification number of the measuring device 602 and the receiving device identification number of the receiving device 604. The registration message may be transmitted together with a data message as one single message which further includes the physiological parameter that the measuring device 602 detects most recently. The receiving device 604 may register the measuring device 602 upon receiving the registration message from the measuring device 602. In one embodiment, the receiving device 604 displays the physiological parameter contained in a data message on a display 620 so that the healthcare personnel may read the physiological parameter of the subject, e.g. patient 616.

FIG. 7 shows an exemplary embodiment wherein the receiving device 704 may register more than one measuring device, i.e. measuring devices 702, 732, and 742.

The receiving device 704 may be the same as the receiving device 304. The receiving device 704 may include a display unit and is not connected to a physiological parameter monitoring device. The receiving device 704 may be the same as the receiving device 604.

For example, the measuring device 702 is mounted on the patient 716, the measuring device 732 is mounted on the patient 736, and the measuring device 742 is mounted on the patient 746. The measuring devices 702, 732, and 742 may each measure a physiological parameter, e.g. body temperature, of patients 702, 732, and 742, respectively.

The receiving device 704 may send request messages to measuring devices 702, 732, and 742 one by one. Alternately, the receiving device 704 may send a request message to all the three measuring devices 702, 732, and 742 at the same time provided that the measuring devices 702, 732, and 742 are all capable of receiving the request message from the receiving device 704. Each measuring device may, upon receiving the request message from the receiving device 704, transmit a registration message including the measuring device identification number and the receiving device identification number of the receiving device 704. For example, the measuring device 702 may include the receiving device identification number of the receiving device 704 and the measuring device identification number, e.g. 1, of the measuring device 702 in the registration message sent by the measuring device 702. The measuring device 732 may include the receiving device identification number of the receiving device 704 and the measuring device identification number, e.g. 2, of the measuring device 732 in the registration message sent by the measuring device 732. The measuring device 742 may include the receiving device identification number of the receiving device 704 and the measuring device identification number, e.g. 3, of the measuring device 742 in the registration message sent by the measuring device 742. The receiving device 704 may register each of the measuring devices 702, 732 and 742. For example, each of the measuring devices 702, 732, and 742 may transmit the respective measured physiological parameter in each respective data message continuously or periodically after receiving the request message. The receiving device 704 may process the physiological parameter in a data message if the measuring device which transmitted the data message has been registered by the receiving device 704. In one example, a healthcare personnel may press a button 722 on the receiving device 704 to initiate the receiving device 704 to transmit the request message. In one example, the receiving device 704 may further include a display 720 which may display the received physiological parameters from each of the measuring devices 702, 732, and 742. In one example, the receiving device 704 may further display the corresponding measuring device identification number besides each physiological parameter. For example, as shown in FIG. 7, the display 720 displays the identification number, i.e. 1, of the measuring device 702 besides the physiological parameter, i.e. body temperature of 37.3° C., transmitted by the measuring device 702. Similarly, the display 720 also displays the identification number, i.e. 2, of the measuring device 732 besides the physiological parameter, i.e. body temperature of 37.8° C., transmitted by the measuring device 732. Similarly, the display 720 also displays the identification number, i.e. 3, of the measuring device 742 besides the physiological parameter, i.e. body temperature of 38.3° C., transmitted by the measuring device 742. The display 720 may be configured to display any suitable number of physiological parameters. The receiving device 704 may register any number of measuring devices as desired.

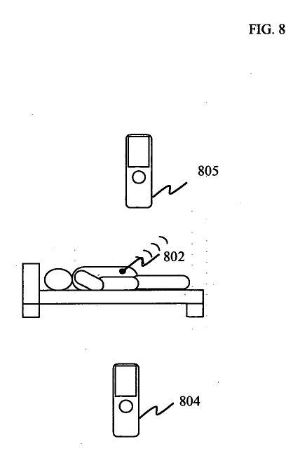

FIG. 8 illustrates an embodiment wherein after a measuring device 802 receives a request message from a receiving device 804, the measuring device 802 may further receive another request message from another receiving device 805.

In one example, the receiving device 804 may send a request message including the receiving device identification number of the receiving device 804. The measuring device 802 may then receive the request message and transmit a registration message which includes the measuring device identification number of the measuring device 802 and the receiving device identification number of the receiving device 804. The registration message may be sent with a data message which includes the physiological parameter that the measuring device 802 detects most recently as a single message. The receiving device 804 may receive the registration message from the measuring device 802, and register the measuring device 802 as a pairing device of the receiving device 804. The measuring device 802 may transmit registration messages continuously or periodically regardless of whether the measuring device 802 has received any request message. Alternatively, the measuring device 802 may only transmit the registration message upon receiving the request message from the receiving device 804. Further, the measuring device 802 may transmit one or several registration messages upon receiving the request message or transmit registration messages continuously or periodically upon receiving the request message. The measuring device 802 may keep transmitting data messages continuously or periodically regardless of whether the measuring device has received any request message. In this scenario, the data message may be transmitted with the registration message as a single message. That is, each single message may include the measuring device identification number and the physiological parameter from the measuring device 802. Alternatively, the measuring device 802 may transmit one or more data messages only if the measuring device 802 has received a request message. Each data message may be transmitted with a registration message as a single message. After the receiving device 804 has registered the measuring device 802, another receiving device 805 may send a request message to the measuring device 802. The measuring device 802 may transmit a registration message wherein the registration message includes the measuring device identification number of the measuring device 802 and the receiving device identification number of the receiving device 805, but not the receiving device identification number of the receiving device 804. The receiving device 804 may receive such a registration message and determine that the registration message includes a receiving device identification number being different from the receiving device identification number of the receiving device 804. In one embodiment, the receiving device 804 may then deregister the measuring device 802 as a pairing device and disregard further data messages from the measuring device 802. In an alternative embodiment, the registration of the measuring device 802 by the receiving device 804 may remain intact. The receiving device 805 may register the measuring device 802 as a pairing device of the receiving device 805. It should be understood that each of the receiving devices 804 and 805 may be also connected to a physiological parameter monitoring device.

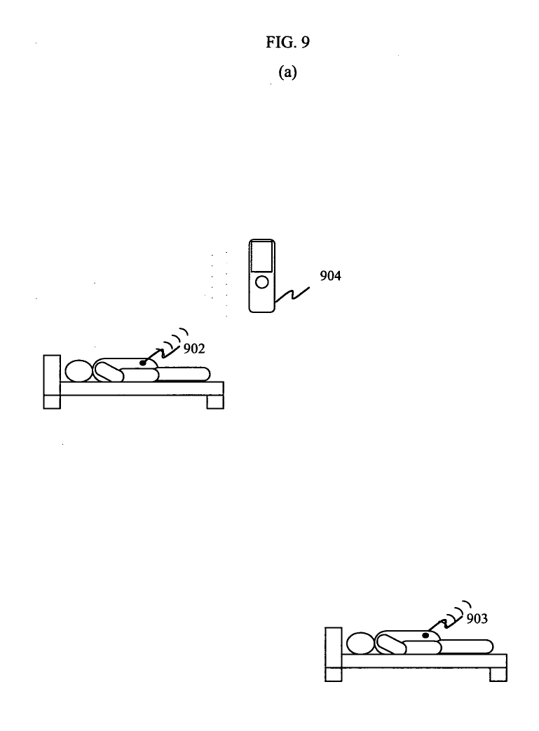

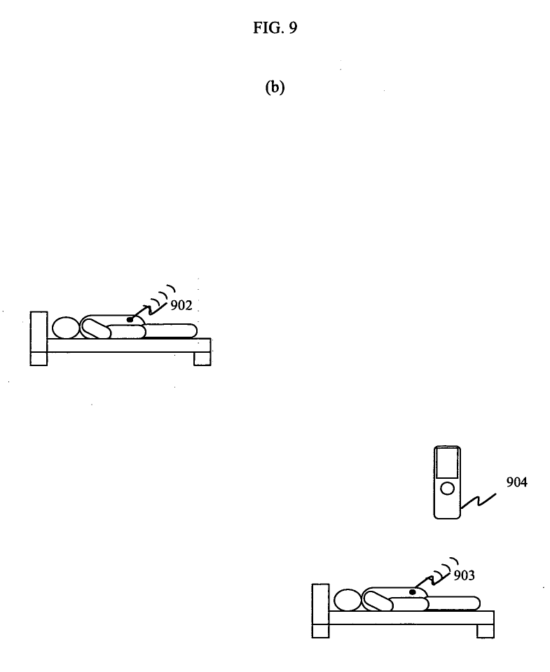

FIGS. 9(a) and 9(b) illustrate an embodiment wherein the range of the transmission of a request message between a receiving device 904 and a measuring device 902 is shorter than the range of the transmission of the data message between the measuring device 902 and the receiving device 904, or the range of the transmission of the registration message between the measuring device 902 and the receiving device 904 is shorter than the range of the transmission of the data message between the measuring device 902 and the receiving device 904, or both are true.

Assume there are two measuring devices 902 and 903 in a room and it is intended to have the receiving device 904 register the measuring device 902 only. In FIG. 9(a), the receiving device 904 is brought close to the measuring device 902 first in order to have the receiving device 904 register the measuring device 902. For registration purposes, in one embodiment, the distance between the measuring device 902 and the receiving device 904 may be such that the measuring device 902 is able to receive the request message from the receiving device 904 and the receiving device 904 is able to receive the registration message from the measuring device 902. Meanwhile, in order to avoid unintended registration of the measuring device 903 by the receiving device 904, when the receiving device transmits the request message, the distance between the receiving device 904 and the measuring device 903 may be such that the measuring device 903 is not able to receive the request message from the receiving device 904, or the receiving device 904 is not able to receive the registration message from the measuring device 903, or both. Accordingly, after the receiving device transmits a request message, only the measuring device 902 is registered. A person skilled in the art would understand that the receiving device 904 may be coupled to a physiological parameter monitoring device, as illustrated in FIG. 3.

FIG. 9(b) illustrates that after registration of the measuring device 902 by the receiving device 904, the receiving device 904 may be brought farther away from the measuring device 902. It may be desired that the receiving device is able to monitor the data messages transmitted by all the registered measuring devices by the receiving device, e.g. the measuring device 902. Accordingly, in one embodiment, the range of the transmission of the data messages between the measuring device 902 and the receiving device 904 may be longer than the range of the transmission of the request message between the receiving device 904 and the measuring device 902. In an alternative embodiment, the range of the transmission of the data messages between the measuring device 902 and the receiving device 904 may be longer than the range of the transmission of the registration message between the measuring device 902 and the receiving device 904. In a further alternative embodiment, the range of the transmission of the data messages between the measuring device 902 and the receiving device 904 may be longer than both the range of the transmission of the request message between the receiving device 904 and the measuring device 902 and the range of the transmission of the registration message between the measuring device 902 and the receiving device 904.

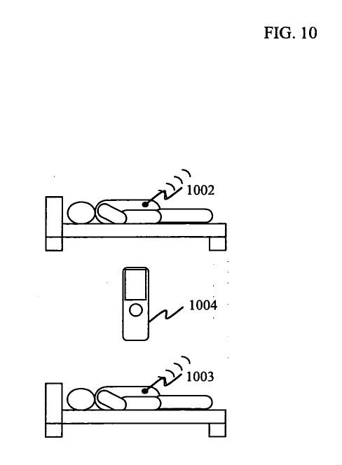

FIG. 10 illustrates an embodiment wherein more than one measuring device may be registered by a receiving device.

As can be seen in FIG. 10, there may be two measuring devices 1002 and 1003, and a receiving device 1004 may be carried to a location such that when the receiving device 1004 transmits a request message, both the measuring device 1002 and the measuring device 1003 are able to receive the request message. In this scenario, both measuring devices 1002 and 1003 may each transmit a registration message in response to the reception of the request message wherein each registration message includes the respective measuring device identification number and the receiving device identification number of the receiving device 1004. The receiving device 1004 may be able to receive the registration messages from both the measuring device 1002 and the measuring device 1003. Thereafter, the receiving device 1004 may register both measuring devices 1002 and 1003 as pairing devices of the receiving device 1004. After the registration, the receiving device 1004 may also be configured to display the respective physiological parameters in data messages transmitted by the measuring devices 1002 and 1003. The receiving device 1004 may also be configured to display the corresponding measuring device identification number beside each physiological parameter.

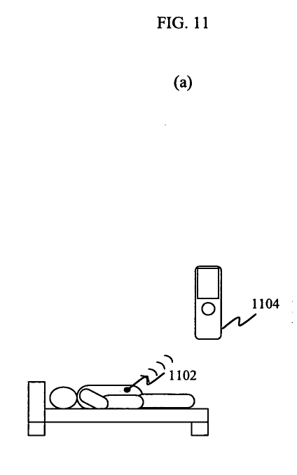

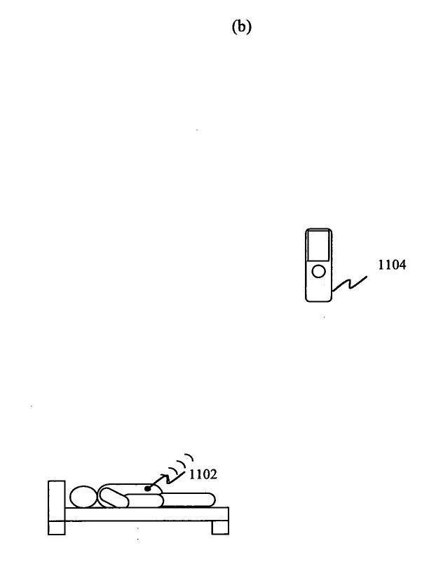

FIG. 11 (a) illustrates a scenario wherein a receiving device 1104 is brought into the vicinity of a measuring device 1102 for registration purposes. The registration range may be referred to as a distance between the measuring device 1102 and the receiving device 1104 such that the measuring device 1102 is able to receive a request message from the receiving device 1104 and the receiving device 1104 is able to receive a registration message from the measuring device 1102.

In one exemplary embodiment, the registration range for the measuring device 1102 and the receiving device 1104 may be, for example, about 20 cm. It is understood that the registration range of about 20 cm is given only for illustration purposes. The registration range may depend on the actual requirements of the implementation of the system. For example, in the scenario where there are a plurality of measuring devices in a room and it is desired that the registration is done one by one, it may be desired that the range for registration is such that when the registration is being done by the receiving device with one of the measuring devices, there is no cross-talk with other measuring devices. The actual registration range may also depend on the size of the room and distance among the measuring devices. In another scenario where it is desired that the receiving device registers all the measuring devices in one room but not any of the measuring devices in another room, it may be desired that the registration range is sufficiently long so that upon the transmission of a request message, all the measuring devices in the room are registered while the measuring devices in the other room are not registered.

In an exemplary embodiment, the receiving device 1104 may use the short range transmitter, e.g. an LF magnetic transmitter, to transmit a request message to the measuring device 1102, and the measuring device 1102 may use a long range receiver, e.g. an RF receiver, to receive the request message.

Alternatively, the receiving device 1104 may use a long range transmitter, e.g. an RF transmitter, to transmit the request message, and the measuring device 1102 may used a short range receiver, e.g. an LF magnetic receiver, to receive the request message.

Alternatively, the receiving device 1104 may use a short range transmitter, e.g. an LF magnetic transmitter, to transmit the request message, and the measuring device 1102 may use a short range receiver, e.g. an LF magnetic receiver, to receive the request message.

In one exemplary embodiment, the measuring device 1102 may use a short range transmitter, e.g. an LF magnetic transmitter, to transmit the registration message, and the receiving device 1104 may use a long range receiver, e.g. an RF receiver, to receive the registration message.

Alternatively, the measuring device 1102 may use a long range transmitter, e.g. an RF transmitter, to transmit the registration message, and the receiving device 1104 may use a short range receiver, e.g. an LF magnetic receiver, to receive the registration message.

Alternatively, the measuring device 1102 may use a short range transmitter, e.g. an LF magnetic transmitter, to transmit the registration message, and the receiving device 1104 may use a short range receiver, e.g. an LF magnetic receiver, to receive the registration message.

FIG. 11(b) illustrates that after the receiving device 1104 registers the measuring device 1102, the receiving device may be taken to a location farther away from the measuring device 1102. The range of the transmission of data messages between the measuring device 1102 and the receiving device 1104 may be at least about 5 meters, for example. As mentioned earlier, this distance is just given for illustration purposes and the actual distance may depend on the actual requirements of the system.

In one embodiment, the receiving device 1104 is at first not connected to a physiological parameter monitoring device, as shown in FIG. 11(a), but is later connected to the physiological parameter monitoring device, as shown in FIG. 11 (b). For example, a healthcare personnel may first bring the receiving device 1104 to within 20 cm of the measuring device 1102 and initiate the receiving device 1104 to send a request message [as shown in FIG. 11 (a)]. The measuring device 1102 receives the request message and sends out a registration message. The receiving device 1104 then registers the measuring device 1102. The healthcare personnel may then bring the receiving device 1104 to another place that is farther away from the measuring device 1102. The healthcare personnel may then connect an output (not shown) of the receiving device 1104 to an input of a physiological parameter measuring device (not shown).

In one example, a receiving device A may have registered a measuring device B as a pairing device of the receiving device A. When a receiving device A does not need to receive any further message from a measuring device B, the receiving device A may send a termination message and deregister the measuring device B from the receiving device. The transmission of the termination message may, for example, be initiated by a healthcare personnel by pressing a button on the receiving device A. The measuring device B may stop to transmit data messages upon reception of the termination message. In another scenario, the receiving device A may be configured to send out a termination message upon being powered off. The measuring device B may then stop to transmit further messages upon receiving the termination message.

Various embodiments as described herein may enable the monitoring of a physiological parameter transmitted by a sub-group of measuring devices among a group of measuring devices. Further, various embodiments further enable conversion of a tethered multi-parameter patient monitor into a wireless continuous patient physiological parameter (e.g. body temperature) monitoring system. In one embodiment, a measuring device may be mounted on a patient's body for measurement and transmission of the physiological parameter. A receiving device may be used to receive the physiological parameter wirelessly and continuously.

Embodiments also provide a method for a receiving device to register a measuring device, or equivalently, for pairing a measuring device with a receiving device. For registration, the range of transmission of a request message between the receiving device and the measuring device, or the range of the transmission of a registration message between the measuring device and the receiving device, or both, is shorter than the range of transmission of the data message between the measuring device and the receiving device. The shorter range(s) for registration purposes (range for transmission of the request message and/or the range for the transmission of the registration message) compared to data transmission may prevent cross-talk from other measuring devices in the vicinity. The measuring device, upon receiving this request, may transmit a registration message including its own identification number, i.e. the measuring device identification number and the receiving device identification number. The registration message may be transmitted with a data message as a single message wherein the data message includes the physiological parameter, e.g. body temperature, of the subject on which the measuring device is mounted. The receiving device may then associate itself with this measuring device identification number and ignore data transmitted by other measuring devices. The range of the transmission of the request message between the receiving device and the measuring device and/or the range of the transmission of the registration message between the measuring device and the receiving device may be up to about 20 cm. The range of the transmission of the data message between the measuring device and the receiving device may be at least about 5 meters. This may allow for wireless continuous monitoring of temperature after pairing is done.

The method as described herein also allows spot or on-demand reading of a physiological parameter. The receiving device may be brought into proximity to a desired measuring device. A button may be pressed to request a physiological parameter from the measuring device using the short range signaling method. The measuring device may then transmit a registration message including the measuring device identification number and the receiving device identification number, together with a data message which includes the physiological parameter, e.g. body temperature, of the subject measured by the measuring device, as one single message using the long range signaling method. In this way, the receiving device is able to receive spot spot or on-demand reading of the physiological parameter.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for monitoring a physiological parameter of a subject by a monitoring system comprising a receiving device and a plurality of measuring devices each measuring a physiological parameter of a respective subject, the method comprising:
transmitting, by a receiving device, a request message which includes a receiving device identification number of the receiving device;
receiving, by the receiving device, a registration message from at least one measuring device of the plurality of measuring devices, the registration message including a measuring device identification number of the at least one measuring device;
registering, by the receiving device, the at least one measuring device by means of the measuring device identification number if the registration message from the at least one measuring device includes the receiving device identification number of the receiving device;
receiving, by the receiving device, one or more data messages from the at least one measuring device, each data message including the measuring device identification number of, and a physiological parameter from, the at least one measuring device; and
processing the physiological parameter in each data message, by the receiving device, if the at least one measuring device has been registered by the receiving device;
wherein the range of the transmission of the request message between the receiving device and the at least one measuring device is shorter than the range of the transmission of each data message between the at least one measuring device and the receiving device, and/or the range of the transmission of the registration message between the at least one measuring device and the receiving device is shorter than the range of the transmission of each data message between the at least one measuring device and the receiving device.

2. The method as claimed in claim 1, wherein the request message is transmitted by the receiving device upon an activation of the receiving device.

3. The method as claimed in claim 1, wherein the at least one measuring device is configured to generate and transmit the registration message continuously or periodically.

4. The method as claimed in claim 1, wherein the at least one measuring device is configured to generate and transmit the registration message only if the at least one measuring device has received the request message.

5. The method as claimed in claim 1, wherein the at least one measuring device is configured to transmit data messages periodically or continuously, each data message including the measuring device identification number of, and a physiological parameter from, the at least one measuring device.

6. The method as claimed in claim 1, wherein the at least one measuring device is configured to transmit data messages periodically or continuously only if the at least one measuring device has received the request message, wherein each data message includes the measuring device identification number of, and a physiological parameter from, the at least one measuring device.

7. The method as claimed in claim 1, further comprising:
generating, by the at least one measuring device, the registration message including the measuring device identification number and, if the request message from the receiving device is received by the at least one measuring device, also the receiving device identification number;
transmitting, by the at least one measuring device, the registration message; and
transmitting, by the at least one measuring device, the one or more data messages.

8. The method as claimed in claim 1, wherein the registration message and each data message are transmitted as one single message.

9. The method as claimed in claim 1, wherein the request message further includes instructions on how frequently the physiological parameter is measured by the at least one measuring device, and/or how frequently the physiological parameter is transmitted by the at least one measuring device.

10. The method as claimed in claim 1, wherein all measuring devices of the plurality of measuring devices, the respective registration message of each containing the receiving device identification number, are registered by the receiving device.

11. The method as claimed in claim 1,
wherein the monitoring system comprises a plurality of receiving devices, and
wherein registration of the at least one measuring device, being already registered by a first receiving device of the plurality of receiving devices, by another receiving device of the plurality of receiving devices terminates registration of the at least one measuring device by said first receiving device.

12. The method as claimed in claim 1,
wherein the monitoring system comprises a plurality of receiving devices, and
wherein registration of the at least one measuring device, being already registered by a first receiving device of the plurality of receiving devices, by another receiving device of the plurality of receiving device does not affect the at least one measuring device registration by said first receiving device.

13. The method as claimed in claim 6, further comprising:
if the at least one measuring device has been registered by the receiving device, transmitting, by the receiving device, a termination message which includes instructions to the at least one measuring device to stop transmitting data messages; and
deregistering, by the receiving device, the at least one measuring device.

14. The method as claimed in claim 13, wherein the receiving device is configured to transmit the termination message upon being powered off.

15. The method as claimed in claim 13, wherein the at least one measuring device is configured to stop transmitting the data messages and registration messages upon receiving the termination message.

16. The method as claimed in claim 1, further comprising:
transmitting, by the receiving device, the request message through a short range transmitter.

17. (canceled)

18. The method as claimed in claim 16, further comprising:
receiving, by the at least one measuring device, the request message from the receiving device through a short range receiver.

19. (canceled)

20. The method as claimed in claim 16, wherein the range of the transmission of the request message between the receiving device and the at least one measuring device is up to about 20 cm.

21. The method as claimed in claim 1, further comprising:
transmitting, by the at least one measuring device, the registration message through a short range transmitter or a long range transmitter.

22. (canceled)

23. The method as claimed in claim 21, further comprising:
receiving, by the receiving device, the registration message through a short range receiver if the at least one measuring device is configured to transmit the registration message through a short range transmitter; or
receiving, by the receiving device, the registration message through a long range receiver if the at least one measuring device is configured to transmit the registration message through a long range transmitter.

24. (canceled)

25. The method as claimed in claim 21,
wherein the range of the transmission of the registration message between the at least one measuring device and the receiving device is up to about 20 cm if the at least one measuring device is configured to transmit the registration message through a short range transmitter and the receiving device is configured to receive the registration message through a short range receiver; and
wherein the range of the transmission of the registration message between the at least one measuring device and the receiving device is at least about 5 meters if the at least one measuring device is configured to transmit the registration message through a long range transmitter and the receiving device is configured to receive the registration message through a long range receiver.

26. The method as claimed in claim 1, further comprising
transmitting, by the at least one measuring device, each data message, or the registration message and each data message as one single message, through a long range transmitter.

27. (canceled)

28. The method as claimed in claim 26, further comprising:
receiving, by the receiving device, each data message or single message through a long range receiver.

29. (canceled)

30. The method as claimed in claim 26, wherein the range of the transmission of each data message or single message between the at least one measuring device and the receiving device is at least about 5 meters.

31. (canceled)

32. The method as claimed in claim 1, further comprising:
displaying, by the receiving device, the physiological parameter in the data message if the at least one measuring device has been registered by the receiving device.

33. The method as claimed in claim 32, wherein the receiving device further displays the measuring device identification number together with the physiological parameter in the data message.

34. The method as claimed in claim 1, further comprising:
coupling an output of the receiving device to an input of a physiological parameter monitoring device.

35. The method as claimed in claim 34, further comprising:
outputting, through the output of the receiving device, one or more electrical or mechanical parameters which correspond to the physiological parameter received by the receiving device from the at least one measuring device, to the input of the physiological parameter monitoring device.

36. The method as claimed in claim 35, further comprising:
receiving, through the input of the physiological parameter monitoring device, the one or more electrical or mechanical parameters by the physiological parameter monitoring device, and
determining, by the physiological parameter monitoring device, a further physiological parameter which corresponds to the one or more electrical or mechanical parameters.

37. The method as claimed in claim 36, further comprising:
displaying, by the physiological parameter monitoring device, the further physiological parameter.

38. (canceled)

39. A method for monitoring a physiological parameter of a subject by a monitoring system comprising a receiving device and a plurality of measuring devices each measuring a physiological parameter of a respective subject, the method comprising:
registering, by the receiving device, at least one measuring device of the plurality of measuring devices by means of a measuring device registration identification number of the at least one measuring device, if a registration message including the measuring device registration identification number of the at least one measuring device from the at least one measuring device has been received by the receiving device;
receiving, by the receiving device, one or more data messages from the at least measuring device, each data message including a measuring device data transmission identification number of, and a physiological parameter from, the at least one measuring device;
processing the physiological parameter in each data message, by the receiving device, if the at least one measuring device has been registered by the receiving device;
wherein the range of the transmission of the registration message between the at least one measuring device and the receiving device is shorter than the range of the transmission of each data message between the at least one measuring device and the receiving device.

40. A monitoring system comprising a receiving device and a plurality of measuring devices each measuring a physiological parameter of a respective subject,
wherein the receiving device is configured to transmit a request message which includes a receiving device identification number of the receiving device;
wherein the receiving device is further configured to receive a registration message from at least one measuring device of the plurality of measuring devices, the registration message including a measuring device identification number of the at least one measuring device;
wherein the receiving device is further configured to register the at least one measuring device by means of the measuring device identification number if the registration message from the at least one measuring device includes the receiving device identification number of the receiving device;
wherein the receiving device is further configured to receive one or more data messages from the at least one measuring device, each data message including the measuring device identification number of, and a physiological parameter from, the at least one measuring device; and
wherein the receiving device is further configured to process the physiological parameter in each data message, if the at least one measuring device has been registered by the receiving device;
wherein the range of the transmission of the request message between the receiving device and the at least one measuring device is shorter than the range of the transmission of each data message between the at least one measuring device and the receiving device, and/or the range of the transmission of the registration message between the at least one measuring device and the receiving device is shorter than the range of the transmission of each data message between the at least one measuring device and the receiving device.

41. The system as claimed in claim 40, wherein the receiving device is configured to transmit the request message upon an activation of the receiving device.

42. The system as claimed in claim 40, wherein the at least one measuring device is configured to generate and transmit the registration message continuously or periodically.

43. The system as claimed in claim 40, wherein the at least one measuring device is configured to generate and transmit the registration message only if the at least one measuring device has received the request message.

44. The system as claimed in claim 40,
wherein the at least one measuring device is configured to transmit data messages periodically or continuously, each data message including the measuring device identification number of, and a physiological parameter from, the at least one measuring device.

45. The system as claimed in claim 40, wherein the at least one measuring device is configured to transmit data messages periodically or continuously only if the at least one measuring device has received the request message, each data message including the measuring device identification number of, and a physiological parameter from, the at least one measuring device.

46. The system as claimed in claim 40,
wherein the at least one measuring device is configured to generate the registration message including the measuring device identification number and, if the request message from the receiving device is received by the at least one measuring device, also the receiving device identification number;
wherein the at least one measuring device is configured to transmit the registration message and the one or more data messages.

47. The system as claimed in claim 40, wherein the registration message and each data message are transmitted as one single message.

48. The system as claimed in claim 40, wherein the request message further includes instructions on how frequently the physiological parameter is measured by the at least one measuring device, and/or how frequently the physiological parameter is transmitted by the at least one measuring device.

49. The system as claimed in claim 40, wherein all measuring devices of the plurality of measuring devices, the respective registration message of each containing the receiving device identification number, are registered by the receiving device.

50. The system as claimed in claim 40, comprising a plurality of receiving devices, wherein registration of the at least one measuring device, being already registered by a first receiving device of the plurality of receiving devices, by another receiving device of the plurality of receiving devices terminates registration of the at least one measuring device by said first receiving device.

51. The system as claimed in claim 40, comprising a plurality of receiving devices, wherein registration of the at least one measuring device, being already registered by a first receiving device of the plurality of receiving devices, by another receiving device of the plurality of receiving devices does not affect the at least one measuring device registration by said first receiving device.

52. The system as claimed in claim 45, wherein if the at least one measuring device has been registered by the receiving device, the receiving device is configured to transmit a termination message including instructions to the at least one measuring device to stop transmitting data messages and registration messages, and to deregister the at least one measuring device.

53. The system as claimed in claim 52, wherein the receiving device is configured to transmit the termination message upon being powered off.

54. The system as claimed in claim 52, wherein the at least one measuring device is configured to stop transmitting the data messages and registration messages upon receiving the termination message.

55. The system as claimed in claim 40, wherein the receiving device is configured to transmit the request message through a short range transmitter.

56. (canceled)

57. The system as claimed in claim 55, wherein the at least one measuring device is configured to receive the request message through a short range receiver.

58. (canceled)

59. The system as claimed in claim 55, wherein the range of the transmission of the request message between the receiving device and the at least one measuring device is up to about 20 cm.

60. The system as claimed in claim 40, wherein the at least one measuring device is configured to transmit the registration message through a short range transmitter or a long range transmitter.

61. (canceled)

62. The system as claimed in claim 60,
wherein the receiving device is configured to receive the registration message through a short range receiver if the at least one measuring device is configured to transmit the registration message through a short range transmitter; and
wherein the receiving device is configured to receive the registration message through a long range receiver if the at least one measuring device is configured to transmit the registration message through a long range transmitter.

63. (canceled)

64. The system as claimed in claim 60,
wherein the range of the transmission of the registration message between the at least one measuring device and the receiving device is up to about 20 cm if the at least one measuring device is configured to transmit the registration message through a short range transmitter and the receiving device is configured to receive the registration message through a short range receiver; and
wherein the range of the transmission of the registration message between the at least one measuring device and the receiving device is at least about 5 meters if the at least one measuring device is configured to transmit the registration message through a long range transmitter and the receiving device is configured to receive the registration message through a long range receiver.

65. The system as claimed in claim 40, wherein the at least one measuring device is configured to transmit each data message, or the registration message and each data message as one single message, through a long range transmitter.

66. (canceled)

67. The system as claimed in claim 65, wherein the receiving device is configured to receive each data message or single message through a long range receiver.

68. (canceled)

69. The system as claimed in claim 65, wherein the range of the transmission of each data message or single message between the at least one measuring device and the receiving device is at least about 5 meters.

70. (canceled)

71. The system as claimed in claim 40, wherein the receiving device is further configured to display the physiological parameter in the data message if the at least one measuring device has been registered by the receiving device.

72. The system as claimed in claim 71, wherein the receiving device is further configured to display the measuring device identification number together with the physiological parameter in the data message.

73. The system as claimed in claim 40, further comprising:
a physiological parameter monitoring device configured to be coupled to an output of the receiving device.

74. The system as claimed in claim 73, wherein
the receiving device is configured to output, through the output of the receiving device, one or more electrical or mechanical parameters which correspond to the physiological parameter received by the receiving device from the at least one measuring device, to the input of the physiological parameter monitoring device.

75. The system as claimed in claim 74, wherein
the physiological parameter monitoring device is configured to receive, through the input of the physiological parameter monitoring device, the one or more electrical or mechanical parameters, and to determine a further physiological parameter which corresponds to the one or more electrical or mechanical parameters.

76. The system as claimed in claim 75, wherein the physiological parameter monitoring device is configured to display the further physiological parameter.

77. (canceled)
